(19) United States
(12) Patent Application Publication
(10) Pub. No.: US 2023/0130953 A1
(43) Pub. Date: Apr. 27, 2023

(54) RUBBER COMPOUNDS FOR PASSENGER TIRE TREADS AND METHODS RELATING THERETO

(71) Applicant: ExxonMobil Chemical Patents Inc., Baytown, TX (US)

(72) Inventors: Xiao-Dong Pan, Houston, TX (US); Alan A. Galuska, Huffman, TX (US); Feng Li, Katy, TX (US); Nieves Hernandez, JR., Humble, TX (US)

(21) Appl. No.: 17/908,179

(22) PCT Filed: Feb. 26, 2021
(86) PCT No.: PCT/US2021/019840

§ 371 Date: Aug. 30, 2022

Related U.S. Application Data
(60) Provisional application No. 62/984,630, filed on Mar. 3, 2020.

(51) Int. Cl. B60C 1/00; C08F 212/08; C08F 236/06; C08G 61/08; C08K 3/04; C08K 3/36

(52) U.S. Cl. CPC B60C 1/0016; C08F 212/08; C08F 236/06; C08G 61/08; C08K 3/04; C08K 3/36; C08F 2500/32; B60C 2200/04; B60C 2011/0033

(57) ABSTRACT

A rubber compound suitable for passenger tires may comprise: 40 to 70 parts by weight per hundred parts by weight rubber (phr) of a long chain branched cyclopentene ring-opening rubber (LCB-CPR) having a glass transition temperature (Tg) of −120° C. to −80° C., a g′ᵥᵢₛ of 0.50 to 0.91, and a ratio of cis to trans of 40:60 to 5:95, 30 phr to 60 phr of a styrene-butadiene rubber (SBR), wherein the SBR has a glass transition temperature (Tg) of −60° C. to −5° C., 50 phr to 110 phr of a reinforcing filler, and 20 phr to 50 phr of a process oil.

### CROSS REFERENCE TO RELATED APPLICATIONS

This application claims the priority benefit of U.S. Provisional Application No. 62/984,630, filed Mar. 3, 2020, the disclosure of which is incorporated herein by reference.

This application is related to U.S. Ser. No. 62/984,636, a provisional patent application having Attorney Docket No. 2020EM099 and entitled “Rubber Compounds for Heavy-Duty Truck and Bus Tire Treads and Methods Relating Thereto”.

### FIELD OF THE INVENTION

The present disclosure relates to rubber compounds comprising styrene-butadiene rubber (SBR) and long chain branched cyclopentene ring-opening rubber (LCB-CPR) that are suitable for use in passenger car tire treads.

### BACKGROUND

The global automotive tire market has grown significantly over the past decade, which can be attributed to the increasing need of high performance tires over a variety of vehicle types (e.g., passenger cars, heavy duty trucks, and the like). Consequently, adaptation to the automotive landscape has become a crucial investment by the tire companies, seeking to meet the changing demands for durability and other important tire properties (e.g., rolling resistance, tread wear, and wet traction). The tread rubber formulations play an essential role in achieving the performance targets for such properties. However, tire performance properties like rolling resistance and wet grip are inversely related such that an improvement in one of these properties is to the detriment of the other. Accordingly, the tire industry faces constant challenges for developing new and improved materials that would lead to improvement in all of the desired tire performance.

Typically, tire tread rubber formulations include a blend of rubbers of varied glass transition temperatures. Commonly, rubbers having low glass transition temperatures (Tg) are known to improve tread wear and rolling resistance, while rubbers having high Tg typically improve traction characteristics. Particularly, rubbers having low Tg can improve rolling loss and wear resistance, though, at the expense of skid-resistance properties. Hence, seeking for the optimal formulation to reach the desired properties described above is still ongoing.

The most commonly used synthetic tire rubbers are styrene-butadiene rubber (SBR) and polybutadiene rubber (BR). The production of such synthetic rubbers traditionally employs Ziegler-Natta catalysis. The resulting rubber microstructure holds a significant role in the tire properties in terms of manufacturing as the microstructure relates to different polymer properties, such as glass transition temperature and crystallinity. Therefore, the control of the rubber microstructure in synthetic rubbers may be used to tune the properties of the resultant rubber formulation.

Cyclopentene ring-opening rubbers (CPR) have been developed as an alternative to BR and SBR. CPR are obtained by ring-opening polymerization (ROMP) of cyclopentene (cC5), producing a branchless polymer chain. However, the resulting cross-linked rubber from CPR have been typically insufficient in wet grip for passenger tires.

For decades, reinforcing fillers (e.g., precipitated amorphous silicas and carbon blacks) have been used in the rubber industry in order to increase the usefulness of the rubbers. The presence of the reinforcing fillers in the tire tread rubber formulations can achieve longer-wearing products and increase the tire strength. Further, replacing the conventional reinforcing filler carbon black with highly-dispersible precipitated silica can result in a significant rolling loss reduction and a remarkable wet skid resistance improvement. However, reduction in rubber strength, deterioration of processability, and poor wear resistance have been observed for silica-filled rubbers, when compared to the carbon black-filled rubbers. Moreover, when a reinforcing filler silica is employed, organosilanes are needed to achieve a rubber blend where the rubber and silica filler have good interaction. However, organosilanes are high-cost inorganic processing aids. Accordingly, a cost-effective enhanced interaction between the reinforcing fillers and the rubber materials is highly desired.

References of interest include U.S. Pat. Nos. 3,598,796, 3,631,010, 3,707,520, 3,778,420, 3,925,514, 3,941,757, 4,002,815, 4,239,484, 5,120,779, 8,227,371, 8,604,148, 8,889,786, 8,889,806, 9,708,435, and 10,072,101; US patent application publication number: US 2002/0166629, US 2009/0192277, US 2012/0077945, US 2013/0041122, US 2016/0002382, US 2016/0289352, US 2017/0233560, US 2017/0247479, US 2017/0292013, and US 2018/0244837; European patent number: EP 2524935; Canadian patent number: CA 1,074,949; Chinese Pat. App. Pub. No. 2018/8001293; WO patent application publication number WO 2018/173968, Japanese patent application publication numbers JP 2019/081839A and JP 2019/081840A; Yao et al. (2012) “Ring-Opening Metathesis Copolymerization of Dicyclopentadiene and Cyclopentene Through Reaction Injection Molding Process,” Jrnl. of App. Poly. Sci., v.125, pp. 2489-2493 (2012), and Haas, F. et al. (1970) “Properties of a Trans-1,5-Polypentenamer Produced by Polymerization through Ring Cleavage of Cyclopentene” Rubber Chemistry and Technology, v.43(5) pp. 1116-1128.

### SUMMARY OF THE INVENTION

The present disclosure relates to rubber compounds comprising styrene-butadiene rubber (SBR) and long chain branched cyclopentene ring-opening rubber (LCB-CPR) that are suitable for use in passenger car tire treads, and other articles comprising such blends of SBR and LCB-CPR.

A rubber compound of the present disclosure for passenger tires may comprise: 40 to 70 parts by weight per hundred parts by weight rubber (phr) of a long chain branched cyclopentene ring-opening rubber (LCB-CPR) having a glass transition temperature (Tg) of −120° C. to −80° C., a g′ᵥᵢₛ of 0.50 to 0.91, and a ratio of cis to trans of 40:60 to 5:95, 30 phr to 60 phr of a styrene-butadiene rubber (SBR), wherein the SBR has a glass transition temperature (Tg) of −60° C. to −5° C., 50 phr to 110 phr of a reinforcing filler, and 20 phr to 50 phr of a process oil.

A method of the present disclosure may comprise: compounding: 40 to 70 parts by weight per hundred parts by weight rubber (phr) of a long chain branched cyclopentene ring-opening rubber (LCB-CPR) having a glass transition temperature (Tg) of −120° C. to −80° C., a g′ᵥᵢₛ of 0.50 to 0.91, and a ratio of cis to trans of 40:60 to 5:95; 30 phr to 60 phr of a styrene-butadiene rubber (SBR), wherein the SBR has a glass transition temperature (Tg) of −60° C. to −5° C.; 50 phr to 110 phr of a reinforcing filler; and 20 phr to 50 phr of a process oil to form a rubber compound. The method may further comprise: molding the rubber compound into a passenger tire tread.

A passenger tire tread of the present disclosure may comprise: a rubber compound that comprises: 40 to 70 parts by weight per hundred parts by weight rubber (phr) of a long chain branched cyclopentene ring-opening rubber (LCB-CPR) having a glass transition temperature (Tg) of −120° C. to −80° C., a g′ᵥᵢₛ of 0.50 to 0.91, and a ratio of cis to trans of 40:60 to 5:95, 30 phr to 60 phr of a styrene-butadiene rubber (SBR), wherein the SBR has a glass transition temperature (Tg) of −60° C. to −5° C., 50 phr to 110 phr of a reinforcing filler, and 20 phr to 50 phr of a process oil.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 (FIG. 1) is a copolymer with ¹³C NMR assignments for determining the DCPD cis/trans ratio.

FIG. 2 (FIG. 2) is a copolymer with ¹H NMR assignments for determining the mol % NBE.

FIG. 3 (FIG. 3) is a plot of DIN abrasion volume loss (mm³) versus the amount of BR or LCB-CPR (parts per hundred of rubber or phr).

FIG. 4 (FIG. 4) is a graph depicting the variation of tan δ versus the temperature (° C.) of various blends made of SBR and cis-BR, and filled with carbon black.

FIG. 5 (FIG. 5) is a graph depicting the variation of tan δ versus the temperature (° C.) of various blends made of SBR and LCB-CPR, and filled with carbon black.

FIG. 6 (FIG. 6) is a graph depicting the variation of tan δ versus the temperature (° C.) of various blends made of SBR and cis-BR, or SBR and LCB-CPR, and filled with silica.

FIG. 7 (FIG. 7) is a plot wet traction predictor tan δ at −8° C. versus rolling loss predictor tan δ at −60° C.

### DETAILED DESCRIPTION

The present disclosure relates to rubber compounds comprising SBR and LCB-CPR that are suitable for use in passenger car tire treads, and other articles comprising such blends of SBR and LCB-CPR. Passenger car tire treads may have a tread depth of 15/32 inches or less, or 2/32 inches or greater, or 3/32 inches to 15/32 inches, or 9/32 inches to 12/32 inches.

Embodiments of the present disclosure include rubber compounds comprising an immiscible blend of (a) a long chain branched cyclopentene ring-opening rubber (LCB-CPR) (e.g., present at 40 phr to 70 phr, or 50 phr to 60 phr) having a glass transition temperature (Tg) of −120° C. to −80° C. (or −110° C. to −85° C., or −100° C. to −90° C.), (b) a styrene-butadiene rubber (SBR) (e.g., present at 30 phr to 60 phr, or 40 phr to 50 phr) having a Tg of −60° C. to −5° C. (or −50° C. to −5° C., or −40° C. to −10° C.), (c) one or more reinforcing filler(s) (e.g., present at 50 phr to 110 phr, or 70 phr to 90 phr), and (d) a process oil (e.g., present at 20 phr to 50 phr, or 30 phr to 40 phr). Advantageously, such compositions provide improved reduction of tire rolling loss, and enhancement of wet skid resistance and wear resistance. Because of these improved properties, the rubber compounds described herein may be useful in producing higher quality passenger car tires. Preferably, the LCB-CPR has a long chain branching (LCB) characterized by g′ᵥᵢₛ of 0.50 to 0.91 (or 0.50 to 0.8, or 0.60 to 0.8, or 0.70 to 0.91), and/or a ratio of cis to trans of 40:60 to 5:95 (30:70 to 10:90, or 20:80 to 10:90, or 15:85).

The present disclosure also relates to the methods for making the foregoing rubber compounds comprising: blending the LCB-CPR with the SBR, reinforcing fillers, a process oil, and optionally other additives.

Said rubber compounds may be useful in tire treads to improve reduction of tire rolling loss, enhance of wet skid resistance, and enhance wear resistance.

### Definitions and Test Methods

The new notation for the Periodic Table Groups is used as described in Chemical and Engineering News, v.63(5), 27 (1985).

Unless otherwise indicated, room temperature is 23° C.

The following abbreviations are used herein: SBR is styrene-butadiene rubber, CPR is cyclopentene ring-opening rubber, BR is polybutadiene rubber, LCB is long chain branched, BHT is butylated hydroxytoluene; Me is methyl; iPr is isopropyl; Ph is phenyl; cC5 is cyclopentene; DCPD is dicyclopentadiene; wt % is weight percent; mol % is mole percent.

An “olefin,” alternatively referred to as “alkene,” is a linear, branched, or cyclic compound of carbon and hydrogen having at least one double bond.

A “polymer” has two or more of the same or different mer units. A “homopolymer” is a polymer having mer units that are the same. The term “polymer” as used herein includes, but is not limited to, homopolymers, copolymers, terpolymers, etc. The term “polymer” as used herein also includes impact, block, graft, random, and alternating copolymers. The term “polymer” shall further include all possible geometrical configurations unless otherwise specifically stated. Such configurations may include isotactic, syndiotactic, and random symmetries.

The term “blend” as used herein refers to a mixture of two or more polymers. Blends may be produced by, for example, solution blending, melt mixing, or compounding in a shear mixer. Solution blending is common for making adhesive formulations comprising baled butyl rubber, tackifier, and oil. Then, the solution blend is coated on a fabric substrate, and the solvent evaporated to leave the adhesive.

The term “monomer” or “comonomer,” as used herein, can refer to the monomer used to form the polymer (i.e., the unreacted chemical compound in the form prior to polymerization) and can also refer to the monomer after it has been incorporated into the polymer, also referred to herein as a “[monomer]-derived unit.” Different monomers are discussed herein, including propylene monomers, ethylene monomers, and diene monomers.

“Different” as used to refer to monomer mer units indicates that the mer units differ from each other by at least one atom or are different isomerically.

As used herein, when a polymer is referred to as “comprising, consisting of, or consisting essentially of” a monomer or monomer-derived units, the monomer is present in the polymer in the polymerized/derivative form of the monomer. For example, when a copolymer is said to have a “cyclopentene” content of 35 wt % to 55 wt %, it is understood that the mer unit in the copolymer is derived from cyclopentene in the polymerization reaction and said derived units are present at 35 wt % to 55 wt %, based upon the weight of the copolymer.

The mol ratio of first cyclic olefin comonomer-derived units to second cyclic olefin comonomer-derived units is determined using ¹H NMR where the different chemical shift of a hydrogen atom can be associated with each comonomer. Then, the relative intensity of the NMR associated with said hydrogens provides a relative concentration of each of the comonomers.

The ratio of cis to trans in a polymer is determined by ¹³C NMR using the relevant olefinic resonances. A carbon in a cis configuration has a smaller NMR chemical shift than a carbon in a trans configuration. The exact chemical shift will depend on the other atoms the carbon is bonded to and a configuration of such bond, but by way of non-limiting example, 1-ethyl-3,4-dimethylpyrrolidine-2,5-dione has cis carbon atoms with a ¹³C chemical shift of about 12.9 ppm for trans carbons and a ¹³C chemical shift of about 11.2 ppm for cis carbons. Then, the relative intensity of the NMR associated with said cis and trans carbons provides a relative concentration of each of the comonomers.

Unless otherwise indicated, NMR spectroscopic data of polymers were recorded in a 10 mm tube on a cryoprobe with a field of at least 600 MHz NMR spectrometer at 25° C. using deuterated chloroform (CDCl₃) solvent to prepare a solution with a concentration of 30 mg/mL for ¹H NMR and 67 mg/mL for ¹³C NMR. ¹H NMR was recorded using a 300 flip angle RF pulse, 512 transients, with a delay of 5 seconds between pulses. ¹³C NMR was recorded using a 90° pulse, inverse gated decoupling, a 60 second delay, and 512 transients. Samples were referenced to the residual solvent signal of CDCl₃ at 77.16 ppm for ¹³C and 7.26 ppm for ¹H. Assignments for DCPD (dicyclopentadiene) composition and cis/trans ratio were based on Benjamin Autenrieth, et. al. (2015) “Stereospecific Ring-Opening Metathesis Polymerization (ROMP) of endo-Dicyclopentadiene by Molybdenum and Tungsten Catalysts,” Macromolecules, v.48, pp. 2480-2492. Assignments for cyclopentene (cC5) compositions and cis/trans ratio were based on Dounis et. al. (1995) “Ring-Opening Metathesis Polymerization of Monocyclic Alkenes using Molybdenum and Tungsten Alkylidene (Schrock-Type) Initiators and ¹³C Nuclear Magnetic Resonance Studies of the Resulting Polyalkenamers,” Polymer, v.36(14), pp. 2787-2796, and cC5-DCPD copolymer assignments were based on Dragutan, V. et. al. (2010) Green Metathesis Chemistry: Great Challenges in Synthesis, Catalysis, and Nanotechnology, pp. 369-380. Appearances of the DCPD units in the polymer chain were uniform enough that there is no observable blockiness.

For example, mol % DCPD was calculated from ¹H NMR using the aliphatic region: DCPD (H4) at 3.22 ppm, cC5=(I₅₋₃ₚₚₘ-8*DCPD)/6; DCPD*100/(cC5+DCPD)=mol %, mol % cC5 is 1-DCPD or cC5*100/(DCPD+cC5).

cC5 cis/trans ratio was determined from ¹³C NMR of the vinylene double bond region with the trans peak at 130.47 ppm and cis centered at 129.96 ppm. DCPD and norbornene (NBE) contribution to the region was considered negligible.

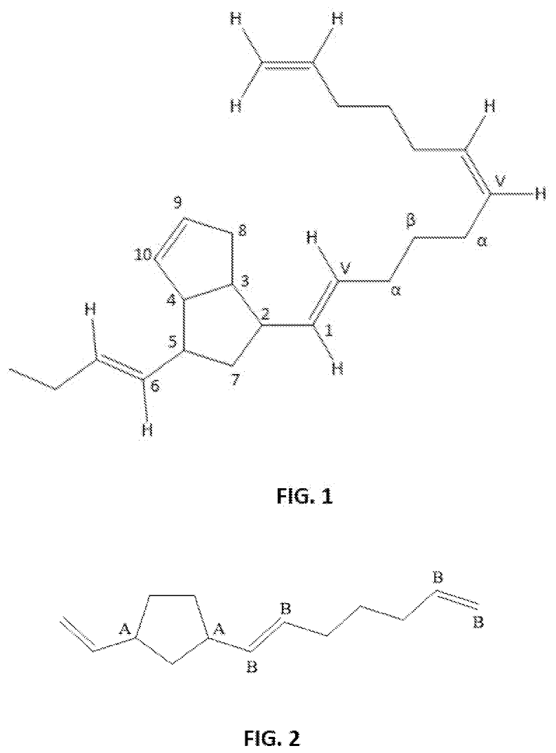

DCPD cis/trans ratio was determined from ¹³C NMR of the C₂ and C₅ peaks per FIG. 1 combined with trans at 47-45.5 ppm and cis at 42.2-41.4 ppm. Both values divided by 2 due to 2 carbons. % Trans=trans*100/(trans+cis) and vice versa.

Mol % NBE was calculated from ¹H NMR using the aliphatic region per FIG. 2 where A and B's designations: NBE (A) at 2.88 ppm, NBE (mol %)=100*(IA/(IB+IA).

Mn is the number average molecular weight, Mw is the weight average molecular weight, and Mz is the z average molecular weight. Molecular weight distribution (MWD) is defined to be Mw divided by Mn. Unless otherwise noted, all molecular weight units (e.g., Mw, Mn, Mz) are g/mol or kDa (1,000 g/mol=1 kDa). The molecular weight distribution, molecular weight moments (Mw, Mn, Mw/Mn) and long chain branching indices were determined by using a Polymer Char GPC-IR, equipped with three in-line detectors, an 18-angle light scattering (“LS”) detector, a viscometer and a differential refractive index detector (“DRI”). Three Agilent PLgel 10 μm Mixed-B LS columns were used for the GPC tests herein. The nominal flow rate was 0.5 mL/min, and the nominal injection volume was 200 μL. The columns, viscometer and DRI detector were contained in ovens maintained at 40° C. The tetrahydrofuran (THF) solvent with 250 ppm antioxidant butylated hydroxytoluene (BHT) was used as the mobile phase. The given amount of polymer samples were weighed and sealed in standard vials. After loading the vials in the auto sampler, polymers were automatically dissolved in the instrument with 8 mL added THF solvent at 40° C. for about two hours with continuous shaking. The concentration, c, at each point in the chromatogram was calculated from the baseline-subtracted DRI signal, I_{DRI}, using the following equation:

c=K_{DRI}I_{DRI}/(dn/dc),

where K_{DRI} is a constant determined by calibrating the DRI, and (dn/dc) is the incremental refractive index of polymer in THF solvent.

The conventional molecular weight was determined by combining universal calibration relationship with the column calibration, which was performed with a series of monodispersed polystyrene (PS) standards ranging from 300 g/mole to 12,000,000 g/mole. The molecular weight “M” at each elution volume was calculated with following equation:

$$log M = \frac{log ( {K}_{P S} / K )}{a + 1} + \frac{{a}_{P S} + 1}{a + 1} log {M}_{P S}$$

where the variables with subscript “PS” stand for polystyrene while those without a subscript are for the test samples. In this method, a_{PS}=0.7362 and K_{PS}=0.0000957 while “a” and “K” for the samples were 0.676 and 0.000521, respectively.

The LS molecular weight, M, at each point in the chromatogram was determined by analyzing the LS output using the Zimm model for static light scattering and determined using the following equation:

$$\frac{{K}_{o} c}{Δ R ( θ )} = \frac{1}{M P ( θ )} + 2 {A}_{2} c .$$

Here, ΔR(θ) is the measured excess Rayleigh scattering intensity at scattering angle θ, “c” is the polymer concentration determined from the DRI analysis, A₂ is the second virial coefficient, P(θ) is the form factor for a mono-disperse random coil, and Kₒ is the optical constant for the system, as set forth in the following equation:

$${K}_{o} = \frac{4 {π}^{2} {{n}^{2} ( dn / dc )}^{2}}{{λ}^{4} {N}_{A}} ,$$

where N_{A} is Avogadro's number, and (dn/dc) is the incremental refractive index for the system, which takes the same value as the one obtained from the DRI method, and the value of “n” is 1.40 for THF at 40° C. and λ=665 nm. For the samples used in this test, the dn/dc is measured as 0.1154 by DRI detector.

A four capillaries viscometer with a Wheatstone bridge configuration was used to determine the intrinsic viscosity [η] from the measured specific viscosity (η_{S}) and the concentration “c.”

η_{S}=c[η]+0.3(c[η])²,

The average intrinsic viscosity, [η]_{avg}, of the sample was calculated using the following equation:

$${[ η ]}_{avg} = \frac{\sum {{c}_{i} [ η ]}_{i}}{\sum {c}_{i}} ,$$

where the summations are over the chromatographic slices, i, between the integration limits.

The branching index (g′ᵥᵢₛ or simply g′) is defined as the ratio of the intrinsic viscosity of the branched polymer to the intrinsic viscosity of a linear polymer of equal molecular weight. The branching index g′ is defined mathematically as:

$${g}^{′} = \frac{{[ η ]}_{a v g}}{k {M}_{v}^{α}} .$$

The Mᵥ is the viscosity-average molecular weight based on molecular weights determined by LS analysis. The Mark-Houwink parameters, a and k, used for the reference linear polymer are 0.676 and 0.000521, respectively.

All the concentration is expressed in g/cm³, molecular weight is expressed in g/mole, and intrinsic viscosity is expressed in dL/g unless otherwise noted.

Differential Scanning Calorimetry (DSC) was used to determine the glass transition temperature (Tg) and the melt temperature (Tm) of a polymer according to ASTM D3418-03. DSC data was be obtained using a TA Instruments model Q200 machine. Samples weighing approximately from 5 mg to 10 mg are placed in an aluminum sample pan and hermetically sealed. The samples are heated to 200° C. at a rate of 10° C./minute and thereafter, held at 200° C. for 2 minutes. The samples are subsequently cooled to −90° C. at a rate of 10° C./minute and held isothermally for 2 minutes at −90° C. A second heating cycle was then performed by heating to 200° C. at 10° C./minute. Tg and Tm are based on the second heating cycle.

As used herein, “phr” means “parts per hundred parts rubber,” where the “rubber” is the total rubber content of the composition. Herein, both SBR and CPR are considered to contribute to the total rubber content, such that in compositions where both are present, the “total rubber” is the combined weight of SBR and CPR. Thus, for example, a composition having 40 parts by weight of CPR and 60 parts by weight of SBR may be referred to as having 40 phr CPR and 60 phr SBR. Other components added to the composition are calculated on a phr basis. For example, addition of 50 phr of oil to a composition means that 50 g of oil are present in the composition for every 100 g of CPR and SBR combined. Unless specified otherwise, phr should be taken as phr on a weight basis.

The phase or loss angle δ, is the inverse tangent of the ratio of G″ (the shear loss modulus) to G′ (the shear storage modulus). For a typical linear polymer, the phase angle at low frequencies (or long times) approaches 90° because the chains can relax in the melt, adsorbing energy and making G″ much larger than G′. As frequencies increase, more of the chains relax too slowly to absorb energy during the shear oscillations, and G′ grows relative to G″. In contrast, a branched chain polymer relaxes very slowly even at temperatures well above the melting temperature of the polymer, because the branches need to retract before the chain backbone can relax along its tube in the melt. This polymer never reaches a state where all its chains can relax during a shear oscillation, and the phase angle never reaches 90° even at the lowest frequency, ω, of the experiments. These slowly relaxing chains lead to a higher zero shear viscosity. Long relaxation times lead to a higher polymer melt strength or elasticity.

The term “tan δ,” also referred to as tangent delta, is used for describing a compound's behavior under forced vibration (e.g., when a motion is sinusoidal). Particularly, tan δ is the ratio between G″ (the shear loss modulus) and G′ (the shear storage modulus), tan δ=G″/G′. The tan δ value is dependent to the temperature.

As used herein, “tensile strength” means the amount of stress applied to a sample to break the sample. It can be expressed in Pascals or pounds per square inch (psi). ASTM D412-16 can be used to determine tensile strength of a polymer.

“Mooney viscosity” as used herein is the Mooney viscosity of a polymer or polymer composition. The polymer composition analyzed for determining Mooney viscosity should be substantially devoid of solvent. For instance, the sample may be placed on a boiling-water steam table in a hood to evaporate a large fraction of the solvent and unreacted monomers, and then, dried in a vacuum oven overnight (12 hours, 90° C.) prior to testing, in accordance with laboratory analysis techniques, or the sample for testing may be taken from a devolatilized polymer (i.e., the polymer post-devolatilization in industrial-scale processes). Unless otherwise indicated, Mooney viscosity is measured using a Mooney viscometer according to ASTM D1646-17, but with the following modifications/clarifications of that procedure. First, sample polymer is pressed between two hot plates of a compression press prior to testing. The plate temperature is 125° C.+/−10° C. instead of the 50° C.+/−5° C. recommended in ASTM D1646-17, because 50° C. is unable to cause sufficient massing. Further, although ASTM D1646-17 allows for several options for die protection, should any two options provide conflicting results, PET 36 micron should be used as the die protection. Further, ASTM D1646-17 does not indicate a sample weight in Section 8; thus, to the extent results may vary based upon sample weight, Mooney viscosity determined using a sample weight of 21.5 g+/−2.7 g in the D1646-17 Section 8 procedures will govern. Finally, the rest procedures before testing set forth in D1646-17 Section 8 are 23° C.+/−3° C. for 30 minutes in air; Mooney values as reported herein were determined after resting at 24° C.+/−3° C. for 30 minutes in air. Samples are placed on either side of a rotor according to the ASTM D1646-17 test method; torque required to turn the viscometer motor at 2 rpm is measured by a transducer for determining the Mooney viscosity. The results are reported as Mooney Units (ML, 1+4 at 125° C.), where M is the Mooney viscosity number, L denotes large rotor (defined as ML in ASTM D1646-17), 1 is the pre-heat time in minutes, 4 is the sample run time in minutes after the motor starts, and 125° C. is the test temperature. Thus, a Mooney viscosity of 90 determined by the aforementioned method would be reported as a Mooney viscosity of 90 MU (ML, 1+4 at 125° C.). Alternatively, the Mooney viscosity may be reported as 90 MU; in such instance, it should be assumed that the just-described method is used to determine such viscosity, unless otherwise noted. In some instances, a lower test temperature may be used (e.g., 100° C.), in which case Mooney is reported as Mooney Viscosity (ML, 1+4 at 100° C.), or at T° C. where T is the test temperature.

The compression set of a material is a permanent deformation remaining after release of a compressive stress. The compression set of a material is dependent of the crosslinking density of the material, which is defined as the torque difference between a maximum torque (also referred to as “MH”) and a minimum torque (also referred to as “ML”). MH, ML, and the torque difference “MH-ML” are evaluated by a Moving Die Rheometer (MDR) testing method, a standard testing method of rubber curing. The MDR can be measured by the ASTM D5289 method, often reported in deciNewton meter (dN.m).

Numerical ranges used herein include the numbers recited in the range. For example, the numerical range “from 1 wt % to 10 wt %” includes 1 wt % and 10 wt % within the recited range.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” or “having” various components or steps, the compositions and methods can also “consist essentially of” or “consist of” the various components and steps.

### Rubber Compounds and Compounding

Rubber compounds described herein comprise: 40 phr to 70 phr (or 42.5 phr to 67.5 phr, or 45 phr to 65 phr, or 47.5 phr to 62.5 phr, or 50 phr to 60 phr) of a long chain branched cyclopentene ring-opening rubber (LCB-CPR) having a glass transition temperature (Tg) of −120° C. to −80° C. (or −110° C. to −85° C., or −100° C. to −90° C.), a g′ᵥᵢₛ of 0.50 to 0.91 (or 0.50 to 0.8, or 0.60 to 0.8, or 0.70 to 0.91), and a ratio of cis to trans of 40:60 to 5:95 (30:70 to 10:90, or 20:80 to 10:90, or 15:85); 30 phr to 60 phr (or 32.5 phr to 57.5 phr, or 35 phr to 55 phr, or 37.5 phr to 52.5 phr, or 40 phr to 50 phr) of a styrene-butadiene rubber (SBR) having a Tg of −60° C. to −5° C. (or −50° C. to −5° C., or −40° C. to −10° C.); 50 phr to 110 phr (or 70 phr to 90 phr, or 73 phr to 87 phr, or 76 phr to 84 phr, or 78 phr to 82 phr) of a reinforcing filler; and 20 phr to 50 phr (or 22 phr to 48 phr, or 24 phr to 46 phr, or 26 phr to 44 phr, or 28 phr to 42 phr, or 30 phr to 40 phr) of a process oil.

Rubber compounds described herein can comprise a single LCB-CPR or a mixture of two or more LCB-CPRs (e.g., a dual reactor product or a melt blended composition).

The LCB-CPR may be present in the rubber compound at 40 phr to 70 phr, or 42.5 phr to 67.5 phr, or 45 phr to 65 phr, or 47.5 phr to 62.5 phr, or 50 phr to 60 phr. LCB-CPR compositions are described further below.

The SBR may be present in the rubber compound at 30 phr to 60 phr, or 32.5 phr to 57.5 phr, or 35 phr to 55 phr, or 37.5 phr to 52.5 phr, or 40 phr to 50 phr. SBR compositions are described further below.

The reinforcing fillers may be present in the rubber compound at 50 phr to 110 phr, 70 phr to 90 phr, or 73 phr to 87 phr, or 76 phr to 84 phr, or 78 phr to 82 phr. Reinforcing fillers are described further below. Examples of reinforcing fillers include, but are not limited to, carbon black and mineral reinforcing fillers.

Carbon black reinforcing fillers (e.g., having particle size from 20 nm to 600 nm and structure having a iodine absorption number within the range from 0 gI/kg to 150 gI/kg, as measured by the ASTM D1510 test method). Compositions of the present disclosure may comprise carbon black from 1 phr to 500 phr, preferably from 1 phr to 200 phr, or from 50 phr to 150 phr, preferably from 40 phr to 100 phr, or 50 phr to 90 phr, or 60 phr to 80 phr.

Mineral reinforcing fillers (talc, calcium carbonate, clay, silica, aluminum trihydrate, and the like), which may be present in the rubber compound from 1 phr to 200 phr, preferably from 20 phr to 100 phr, or from 30 phr to 60 phr.

The LCB-CPRs of the present disclosure exhibit a strong affinity to the reinforcing fillers, particularly to the carbon black reinforcing filler, which improves the wet traction while maintaining the roll resistance, as compared to BR/SBR blends. Further, silica-filled rubber compounds typically exhibit improved wet traction but poor dry traction, when compared to carbon-filled rubber compounds. The present disclosure provides a carbon-filled rubber compounds with better wet traction and similar or better rolling loss when compared to Si-filled rubber compounds.

The process oil may be present in the rubber compound at 20 phr to 50 phr, or 22 phr to 48 phr, or 24 phr to 46 phr, or 26 phr to 44 phr, or 28 phr to 42 phr, or 30 phr to 40 phr.

Process oil, such as aromatic process oil (any suitable examples of aromatic oils including SUNDEX™ 8125TN (available from HollyFrontier Refining & Marketing LLC, Tulsa, Okla.), or paraffinic and/or isoparaffinic process oil (examples including SUNPAR™ (available from HollyFrontier Refining & Marketing LLC, Tulsa, Okla.), FLEXON™ 876, CORE™ 600 base stock oil, FLEXON™ 815, and CORE™ 2500 base stock oil, available from ExxonMobil Chemical Company, Baytown, Tex. Particularly in embodiments where color of the end product may be important, a white oil (e.g., API Group II or Group III base oil) may be used as process oil. Examples include paraffinic and/or isoparaffinic oils with low (under 1 wt %, such as under 0.1 wt %) aromatic and heteroatom content. Preferred process oils are aromatic oils having a viscosity at 40° C. from 500 cSt to 2000 cSt (e.g., SUNDEX™ 8125TN: viscosity at 40° C. of 695 cSt, as measured with ASTM D445 test method; SUNDEX™ 8600TN: viscosity at 40° C. of 1307 cSt, as measured with ASTM D445 test method).

The rubber compounds described herein may also include additives that may include, but are not limited to, curatives, crosslinking agents, plasticizers, compatibilizers, and the like, and any combination thereof.

Suitable vulcanization activators include zinc oxide (also referred to as “ZnO”), stearic acid, and the like. These activators may be mixed in amounts ranging from 0.1 phr to 20 phr. Different vulcanization activators may be present in different amounts. For instance, where the vulcanization activator includes zinc oxide, the zinc oxide may be present in an amount from 1 phr to 20 phr, such as from 2.0 phr to 10 phr, such as about 2.5 phr, for example, while stearic acid may preferably be employed in amounts ranging from 0.1 phr to 5 phr, such as from 0.1 phr to 2 phr, such as about 1 phr, for example).

Any suitable vulcanizing agent may be used. Of particular note are curing agents as described in Col. 19, line 35 to Col. 20, line 30 of U.S. Pat. No. 7,915,354, which description is hereby incorporated by reference (e.g., sulfur, peroxide-based curing agents, resin curing agents, silanes, and hydrosilane curing agents). The resin curing agent would enable further tuning of the rubber compound viscoelasticity and improve the material strength. Example of suitable silanes may be Silane X 50-S®, which is a blend of a bi-functional sulfur-containing organosilane Si 69® (bis(triethoxysilylpropyl)tetrasulfide)) and an N330 type carbon black in the ratio 1:1 by weight. Other examples include phenolic resin curing agents (e.g., as described in U.S. Pat. No. 5,750,625, also incorporated by reference herein). Cure co-agents may also be included (e.g., zinc dimethacrylate (ZDMA)) or those described in the already-incorporated description of U.S. Pat. No. 7,915,354).

Further additives may be chosen from any known additives useful for rubber compounds, and include, among others, one or more of:
Vulcanization accelerators: compositions of the present disclosure can comprise 0.1 phr to 15 phr, or 1 phr to 5 phr, or 2 phr to 4 phr, with examples including thiazoles such as 2-mercaptobenzothiazole or mercaptobenzothiazyl disulfide (MBTS); guanidines such as diphenylguanidine; sulfenamides such as N-cyclohexylbenzothiazolsulfenamide; dithiocarbamates such as zinc dimethyl dithiocarbamate, zinc diethyl dithiocarbamate, zinc dibenzyl dithiocarbamate (ZBEC); and zinc dibutyldithiocarbamate, thioureas such as 1,3-diethylthiourea, thiophosphates and others;
Processing aids (e.g., polyethylene glycol or zinc soap);
Where foaming may be desired, sponge or foaming grade additives, such as foaming agent or blowing agent, particularly in very high Mooney viscosity embodiments, such as those suitable for sponge grades. Examples of such agents include: azodicarbonamide (ADC), ortho-benzo sulfonyl hydrazide (OBSH), p-toluenesulfonylhydrazide (TSH), 5-phenyltetrazole (5-PT), and sodium bicarbonate in citric acid. Microcapsules may also or instead be used for such foaming applications. These may include a thermo-expandable microsphere comprising a polymer shell with a propellant contained therein. Suitable examples are described in U.S. Pat. Nos. 6,582,633 and 3,615,972, WIPO Publication Nos. WO 1999/046320 and WO 1999/043758, and contents of which hereby are incorporated by reference. Examples of such thermo-expandable microspheres include EXPANCEL™ products commercially available from Akzo Nobel N.V., and ADVANCELL™ products available from Sekisui. In other embodiments, sponging or foaming may be accomplished by direct injection of gas and/or liquid (e.g., water, CO₂, N₂) into the rubber in an extruder, for foaming after passing the composition through a die; and
Various other additives may also be included, such as antioxidants (e.g., 1,2-dihydro-2,2,4-trimethylquinoline; SANTOFLEX® 6PPD), wax antiozonant (e.g., NOCHEK® 4756A), stabilizers, anticorrosion agents, UV absorbers, antistatics, slip agents, moisture absorbents (e.g., calcium oxide), pigments, dyes or other colorants.

Rubber compounds of the present disclosure may be formed by combining the LCB-CPR, the SBR, the reinforcing filler, the processing oil, and additional additives, as needed, using any suitable method known in the polymer processing art. For example, a rubber compound may be made by blending the LCB-CPR, the SBR, the reinforcing filler, the processing oil, and additional additives, as needed, in solution and generally removing the blend. The components of the blend may be blended in any order.

In at least one instance, a method for preparing a rubber compound of the LCB-CPR and the SBR includes contacting in a first reactor a ROMP catalyst with cyclic monomer(s) (e.g., cC5) to form a LCB-polymer described herein. The method further includes preparing a solution of SBR (either commercially available or formed in situ by using any suitable method for SBR production). Methods can include transferring the LCB-CPR to the second reactor or the SBR to the first reactor and recovering from the second reactor or the first reactor, respectively, a mixture of the LCB-CPR and the SBR. The recovered rubber compound may then be crosslinked, for example, as described in more detail below.

Alternatively, a blend may be prepared by combining LCB-CPR, the SBR from their respective reactions and mixed, for example, in a production extruder, such as the extruder on an injection molding machine or on a continuous extrusion line.

In another example, the method of blending the rubber polymers including LCB-CPR and SBR may be to melt-blend the polymers in a batch mixer, such as a BANBURY™ or BARBENDER™ mixer. Blending may include melt blending the LCB-CPR, the SBR in an extruder, such as a single-screw extruder or a twin-screw extruder. Suitable examples of extrusion technology for polymer blends can be described in more detail in Plastics Extrusion Technology, F. Hensen, Ed. (Hanser, 1988), pp. 26-37, and in Polypropylene Handbook, E. P. Moore, Jr. Ed. (Hanser, 1996), pp. 304-348, which are incorporated herein by reference.

The LCB-CPR and the SBR may also be blended by a combination of methods including, but not limited to, solution blending, melt mixing, compounding in a shear mixer and combinations thereof. For example, dry blending followed by melt blending in an extruder, or batch mixing of some components followed by melt blending with other components in an extruder. The LCB-CPR and the SBR may also be blended using a double-cone blender, ribbon blender, or other suitable blender, or in a FARREL CONTINUOUS MIXER™ (FCM™)

The LCB-CPR, the SBR, the reinforcing filler, the processing oil, and optionally additional additives (e.g., curatives, crosslinking agents (or crosslinkers), plasticizers, compatibilizers, and the like) may be blended in varying orders, which in some instances may alter the properties of the resultant composition.

For example, a master batch that comprises the LCB-CPR and the SBR and additives (except curatives and crosslinking agents) may be produced at a first temperature. Then, the curatives and/or crosslinking agents may be mixed into the master batch at a second temperature that is lower than the first temperature.

In another example, the master batch may be produced by mixing together in one-step the LCB-CPR and the SBR and the additives (except curatives and crosslinking agents) until the additives are incorporated (e.g., producing a homogeneous blend). This is referred to herein as a first pass method or first pass blending. After the first pass blending produces the master batch, the curatives and/or crosslinking agents may be mixed into the master batch to produce the final blend.

In yet another example, a two-step mixing process may be used to produce the master batch. For example, the master batch may be produced by mixing the LCB-CPR with the additives (except curatives and crosslinking agents) until the additives are incorporated into the LCB-CPR (e.g., producing a homogeneous blend). Then, the resultant blend is mixed with the SBR and the curatives and/or crosslinking agents. This is referred to herein as a second pass method or a second pass blending. Alternatively, the curatives and/or crosslinking agents may be mixed into the master batch after addition of the SBR in the second pass to produce the final blend.

In some second pass blendings, mixing the LCB-CPR/additive (except curatives and crosslinking agents) blend with the SBR may be done in a mixer or other suitable system without removing the LCB-CPR/additive blend from the mixer (i.e., first pass blending) to produce the master batch. Alternatively, the LCB-CPR/additive (except curatives and crosslinking agents) blend may be removed from a mixer or other suitable system for producing the blend, and, then, mixed with the SBR in a mixer or other suitable system (i.e., second pass blending) to produce the master batch.

For example, a method for preparing a rubber compound of the LCB-CPR, the SBR, and one or more reinforcing fillers includes mixing one or more reinforcing fillers through at least two stages of mixing. For example, when the reinforcing filler is carbon black, the carbon black-filled rubber compound may go through two stages of mixing. In another example, when the reinforcing filler is silica, the silica-filled composition may go through three stages of mixing.

In embodiments where curatives (e.g., crosslinking agents or vulcanizing agents) are present in a rubber compound, the LCB-CPRs and SBR of the rubber compound may be present in at least partially crosslinked form (that is, at least a portion of the polymer chains are crosslinked with each other, e.g., as a result of a curing process). Accordingly, particular embodiments provide for an at least partially crosslinked rubber compound made by mixing (in accordance with any of the above-described methods for polymer blends) a rubber compound comprising: (a) a LCB-CPR (40 phr to 70 phr) having a Tg of −120° C. to −80° C., having a g′ᵥᵢₛ of 0.50 to 09.1, and a ratio of cis to trans of 40:60 to 5:95 (b) SBR (30 phr to 60 phr) of having a Tg of −60° C. to −5° C.; (c) reinforcing fillers; (d) vulcanization activators, vulcanizing agents, and/or crosslinking agents; and optionally (e) further additives.

The rubber compounds of the present disclosure comprising a cross-linking density (MH-ML) after curing at 160° C., 0.50 for 45 minutes of 10 dN.M to 25 dN.M, or 12.5 dN.M to 22.5 dN.M, or 13 dN.M to 20 dN.M.

The rubber compounds described herein (e.g., comprising LCB-CPR, the SBR, the reinforcing filler, the processing oil, and optionally additional additives) may have a wet skid resistance (tan δ at −8° C., strain at 0.20%) of 0.1 to 0.7, or 0.15 to 0.6, or 0.2 to 0.5.

The rubber compounds described herein (e.g., comprising LCB-CPR, the SBR, the reinforcing filler, the processing oil, and optionally additional additives) may have a wear loss (tan δ at 60° C., strain at 2.0%) of 0.1 to 0.45, or 0.12 to 0.4, or 0.15 to 0.35, or 0.17 to 0.30.

The rubber compounds described herein (e.g., comprising LCB-CPR, the SBR, the reinforcing filler, the processing oil, and optionally additional additives) may have a tire handling (G′ at 60° C., strain at 2.0%) of 4 MPa to 10 MPa, or 5 MPa to 9 MPa, or 6 MPa to 8 MPa.

The rubber compounds described herein (e.g., comprising LCB-CPR, the SBR, the reinforcing filler, the processing oil, and optionally additional additives) may have a DIN abrasion volume loss of 40 mm³ to 130 mm³, or 50 mm³ to 120 mm³, or 60 mm³ to 110 mm³.

### Long Chain Branched CPR

Rubber compounds described herein may comprise: 40 phr to 70 phr (or 42.5 phr to 67.5 phr, or 45 phr to 65 phr, or 47.5 phr to 62.5 phr, or 50 phr to 60 phr) of a LCB-CPR having a glass transition temperature (Tg) of −120° C. to −80° C. (or −110° C. to −85° C., or −100° C. to −90° C.), a g′ᵥᵢₛ of 0.50 to 0.91 (or 0.50 to 0.8, or 0.60 to 0.8, or 0.70 to 0.91), and a ratio of cis to trans of 40:60 to 5:95 (30:70 to 10:90, or 20:80 to 10:90, or 15:85).

Rubber compounds described herein can comprise a single LCB-CPR or a mixture of two or more LCB-CPR (e.g., a dual reactor product or blended LCB-CPRs).

The LCB-CPR may be a branched homopolymer of cyclopentene monomers. Alternatively, the LCB-CPR may be a branched cyclic olefin copolymer produced from cyclopentene and one or more comonomers at a mol ratio of a cyclopentene to the comonomers (cumulatively) of 1:1 to 500:1 (or 5:1 to 250:1, 1:1 to 100:1, 1:1 to 10:1, 5:1 to 50:1, 50:1 to 250:1, or 100:1 to 500:1).

Examples of comonomers include, but are not limited to, cyclooctene, 1,5-cyclooctadiene, 1-hydroxy-4-cyclooctene, 1-acetoxy-4-cyclooctene, 5-methylcyclopentene, dicyclopentadiene (DCPD), norbornene, norbornadiene, cycloheptene, cyclooctene, cyclooctadiene, cyclododecene, 7-oxanorbornene, 7-oxanorbornadiene, cis-5-norbornene-endo-2,3-dicarboxylic anhydride, dimethyl norbornene carboxylate, and norbornene-exo-2,3-carboxylic anhydride.

Cyclic olefins suitable for use as comonomers in the methods of the present disclosure may be strained or unstrained (preferably strained); monocyclic or polycyclic (e.g., bicyclic); and optionally include hetero atoms and/or one or more functional groups.

The LCB-CPRs of the present disclosure may have a melting temperature of 5° C. to 35° C., or 7° C. to 30° C., or 10° C. to 20° C.

The LCB-CPRs of the present disclosure may have a Mw of 1 kDa to 1,000 kDa, or 10 kDa to 1,000 kDa, or 100 kDa to 1,000 kDa, or 250 kDa to 750 kDa, or 250 kDa to 550 kDa.

The LCB-CPRs of the present disclosure may have a Mn of 0.5 kDa to 500 kDa, or 1 kDa to 250 kDa, or 10 kDa to 250 kDa, or 50 kDa to 250 kDa, or 100 kDa to 500 kDa.

The LCB-CPRs of the present disclosure may have a MWD of 1 to 10, or greater than 1 to 10, or 1 to 5, or greater than 1 to 5 or 2 to 4, or 1 to 3, or greater than 1 to 3.

The long chain branching (LCB) can be qualitatively characterized by the analysis of the van Gurp-Palmen (vGP) plot according to the method described by Tinkle et al. (2002) Rheol. Acta, v.41, pg. 103. The vGP plot is a plot of the loss angle versus the magnitude of the complex modulus (|G*|) measured by dynamic oscillatory rheology in the linear viscoelastic regime. A linear polymer is characterized by a monotonic decreasing dependence of the loss angle with |G*| in the vGP plot and along chain branched polymer has a shoulder or a minimum in the vGP plot.

The LCB-CPRs of the present disclosure having a long chain branching structure may have a 6 at a G* of 50 kPa of 30° to 60°, or 30° to 50°, or 30° to 40°. Polymers of the present disclosure having a linear structure may have a δ at a G* of 50 kPa of 65° to 80°, or 70° to 80°, or 700 to 75°.

The LCB-CPRs of the present disclosure may be produced by ring-opening metathesis polymerization (ROMP).

### Metathesis Catalyst Compounds and Polymerization of LCB-CPRs

Catalysts suitable for use in conjunction with the methods described herein are any catalysts capable of performing ROMP. For example, the catalyst is a tungsten or ruthenium metal complex-based metathesis catalyst.

In embodiments according to the instant invention, a process to form a cyclic olefin polymerization catalyst comprises:

i) contacting a metal alkoxide (IIIa) with a transition metal halide (IV) to form a transition metal precatalyst (VIIIa) according to the general formula:

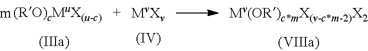

ii) contacting the transition metal precatalyst (VIIIa) with a metal alkyl activator (A) to form the activated catalyst comprising a transition metal carbene moiety M^{v}=C(R*)₂ according to the general formula:

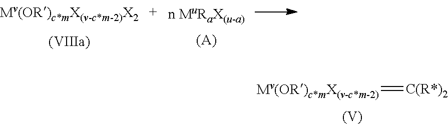

wherein M^{u} is a Group 1, 2, or 13 metal of valance u, preferably Li, Na, Ca, Mg, Al, or Ga;

c is from 1 to 3 and ≤u;

m=1/3, 1/2, 1, 2, 3, or 4 and c*m≤v−2;

a is 1, 2, or 3 and a≤u;

n is a positive number but a*n is in between 2 to 10;

M^{v} is a Group 5 or 6 transition metal of valance v;

X is halogen,

each R′ is independently a monovalent hydrocarbyl comprising from 1 to 20 atoms selected from Groups 14, 15, and 16 of the periodic table;

each R is independently a C₁ to C₈ alkyl;

each R* is independently H or a C₁ to C₇ alkyl; and

each Z is independently halide or a C₁ to C₈ alkyl radical.

Accordingly, embodiments described herein may include Group 1 and Group 2 mono-alkoxides (e.g., Li(OR′) or Mg(OR′)X), Group 2 metal and Group 13 metal dialkoxides (e.g., Mg(OR′)₂ and Al(OR′)₂X), and Group 13 trialkoxide (e.g., Al(OR′)₃), wherein R′ is independently a monovalent hydrocarbyl comprising from 1 to 20 atoms selected from Groups 14, 15, and 16 of the periodic table, and X is halogen. In any embodiment, metal alkoxide (IIIa) may comprise (a) a Group 1 metal, e.g., NaOR′ (u=1, c=1, d=0); (b) a Group 2 metal, e.g., Mg(OR′)Cl (u=2, c=1, d=1), or Mg(OR′)₂ (u=2, c=2, u=0); or (c) a Group 13 metal, e.g., Al(OR′)Cl₂ (u=3, c=1, d=2), Al(OR′)₂Cl (u=3, c=2, d=1), or Al(OR′)₃ (u=3, c=3, d=0).

In embodiments of the invention, the metal alkoxide (IIIa) is formed by contacting a compound comprising a hydroxyl functional group (I) with a Group 1 or Group 2 metal hydride M^{u}*(H)ᵤ according to the general formula:

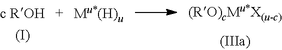

wherein M^{u*} is a Group 1 or 2 metal of valance u*, preferably Na, Li, Ca, or Mg;

c is 1 or 2 and c is ≤u*;

X is halogen; and

each R′ is independently a monovalent hydrocarbyl comprising from 1 to 20 atoms selected from Groups 14, 15, and 16 of the periodic table.

In embodiments of the invention, the metal alkoxide (IIIa) is formed by contacting a compound comprising a hydroxyl functional group (I) with the metal alkyl activator (A) to form the metal alkoxide (IIIa) according to the general formula:

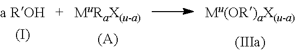

wherein each R′ is independently a monovalent hydrocarbyl comprising from 1 to 20 atoms selected from Groups 14, 15, and 16 of the periodic table;

M^{u} is a Group 1, 2, or 13 metal of valance u, preferably Li, Na, Ca, Mg, Al, or Ga; a is 1, 2, or 3; a is ≤u; and

each R is independently a C₁ to C₈ alkyl.

In embodiments of the invention, the process further comprises contacting a mixture of metal alkoxides with one or more ligand donors (D) under conditions sufficient to crystalize and isolate the metal alkoxide (IIIa) as one or more dimeric coordinated metal alkoxide-donor composition according to the general structure (XXV-GD₂):

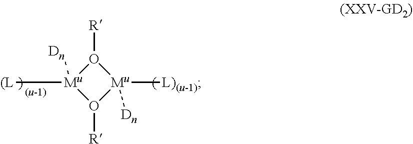

wherein M^{u} is a Group 1, 2, or 13 metal of valance u, preferably Li, Na, Ca, Mg, Al, or Ga;

each R′ is independently a monovalent hydrocarbyl comprising from 1 to 20 atoms selected from Groups 14, 15, and 16 of the periodic table;

each L is R′O—, alkyl R as defined for structure A, or halide X;

each D is any O or N containing organic donor selected from ethers (e.g., dialkyl ethers, cyclic ethers), ketones, amines (e.g., trialkyl amines, aromatic amines, cyclic amines, and heterocyclic amines (e.g., pyridine)), nitriles (e.g., alkyl nitriles and aromatic nitriles), and any combination thereof (preferably, tetrahydrofuran, methyl-tertbutyl ether, a C₁-C₄ dialkyl ether, a C₁-C₄ trialkyl amine, and any combination thereof); and

n is 1, 2, 3, or 4.

In embodiments of the invention, a process to form a cyclic olefin polymerization catalyst comprises contacting an alkyl-metal alkoxide (IIIb) with a transition metal halide (IV) in a reaction mixture to form the activated catalyst (V) comprising a transition metal carbene moiety M^{v}=C(R*)₂ according to the general formula:

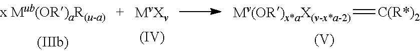

wherein M^{ub} is a Group 2 or 13 metal of valance u, preferably Ca, Mg, Al, or Ga, most preferably Al;

a is 1 or 2 but <u;

x is ½ or 1, 2, 3, or 4 but x*a< or =v−2;

M^{v} is a Group 5 or 6 transition metal of valance v;

X is halogen;

each R′ is independently a monovalent hydrocarbyl comprising from 1 to 20 atoms selected from Groups 14, 15, and 16 of the periodic table;

each R is independently a C₁ to C₈ alkyl; and

each R* is independently H or a C₁ to C₇ alkyl.

In embodiments of the invention, the reaction mixture further comprises a metal alkyl activator (A) according to the formula M^{u}RₐX₍ᵤ₋ₐ₎, wherein M^{u} is a Group 1, 2, or 13 metal of valance u, preferably Li, Na, Ca, Mg, Al, or Ga; a is 1, 2, or 3; a≤u; and when present, X is halogen.

In embodiments of the invention, M^{v} is W, Mo, Nb, or Ta. In some embodiments, two or more R′O— ligands are connected to form a single bidentate chelating moiety.

In one or more embodiments of the invention, a process to form a cyclic olefin polymerization catalyst comprises: (i) and (iia) or (i), (iib1), and (iib2):

i) contacting a compound comprising a hydroxyl functional group (I) with an alkyl aluminum compound (II) to form an aluminum precatalyst (III) and the corresponding residual (Q1+Q2) according to the general formula:

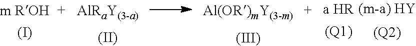

wherein m is 1 or 2;

a is 1 or 2;

each Z is independently H or a C₁ to C₈ alkyl;

each R′ is independently a monovalent hydrocarbyl comprising from 1 to 20 atoms selected from Groups 14, 15, and 16 of the periodic table; and

each Y is a C₁ to C₈ alkyl, halogen, or an alkoxy hydrocarbyl moiety represented by —OR⁵, wherein each R⁵ is a C₁ to C₂₀ alkyl radical and wherein Y═C₁ to C₈ alkyl;

iia) contacting the aluminum precatalyst (III) with a transition metal halide (IV) to form an activated carbene containing cyclic olefin polymerization catalyst (V) comprising a transition metal carbene moiety M^{v}=C(R*)₂ according to the general formula:

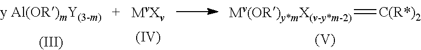

wherein each R* is independently H or a C₁ to C₇ alkyl; or

iib1) contacting the aluminum precatalyst (III) with a transition metal halide (IV) to form a transition metal precatalyst, (VIII) according to the general formula:

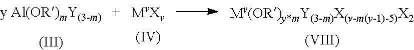

wherein m=1, 2, or 3; y=1/3, 1/2, 1, 2, 3, or 4; y*m+3−m≤v−2; and

iib2) contacting the transition metal precatalyst, (VIII) with a metal alkyl activator (A) to form the activated carbene containing cyclic olefin polymerization catalyst (V) comprising a transition metal carbene moiety M^{v}=C(R*)₂ according to the general formula:

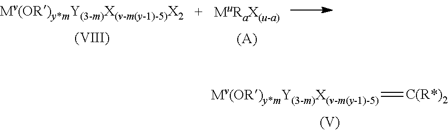

wherein R* is a hydrogen or C₁-C₇ alkyl.

Embodiments in which R* is C₁-C₇ alkyl are preferred because activators in which R* is an alkyl having 8 or more carbon atoms are not capable of directly activating the transition metal halide.

In one or more embodiments of the invention wherein a=3 such, the alkyl aluminum compound (II) is a trialkyl-aluminum (IX) and the residual is an alkane HR according to the general formula:

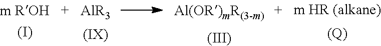

wherein m=1 or 2; and each R is independently a C₁ to C₈ alkyl radical

In embodiments of the process, the aluminum precatalyst (III) is a dimer represented by structure (III-D) which is reacted with the transition metal halide (IV) to form the activated carbene containing cyclic olefin polymerization catalyst (V) according to the general formula:

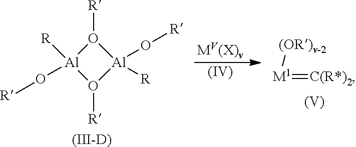

wherein each R is C₁ to C₈ alkyl; each R* is independently hydrogen or C₁ to C₇ alkyl; and

each R′ is independently a monovalent hydrocarbyl comprising from 1 to 20 atoms selected from Groups 14, 15, and 16 of the periodic table, or two or more of R′ are connected to form a bidentate chelating ligand.

In embodiments where a=2 and Y is halogen, the alkyl aluminum compound (II) is a dialkyl aluminum halide (VI), and the aluminum precatalyst is a di-halo tetrakis alkoxide aluminum dimer (VII) according to the general formula:

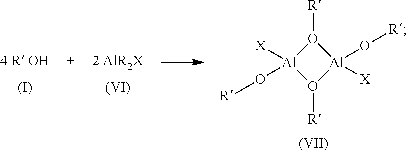

and

Then, the di-halo tetrakis alkoxide aluminum dimer (VII) is contacted with the transition metal halide (IV) to form a di-halo transition metal precatalyst (VIII) according to the general formula:

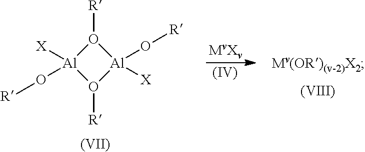

and

wherein the di-halo transition metal precatalyst (VIII) is contacted with a metal alkyl activator (A) to form the activated carbene containing cyclic olefin polymerization catalyst (V) according to the general formula:

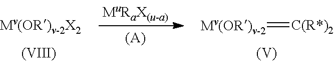

wherein a=1, 2, or 3; and a is ≤u.

In one or more embodiments of the invention, a molar ratio of M^{v} to M^{u}-R in metal alkyl activator M^{u}RₐX₍ᵤ₋ₐ₎ is from 1 to 2 to 1 to 15. In one or more embodiments the alkoxy ligand R′O— comprises a C₇ to C₂₀ aromatic moiety and wherein the O atom directly bonds to the aromatic ring; the compound comprising a hydroxyl functional group (I) is a bidentate dihydroxy chelating ligand (X′); the alkyl aluminum compound (II) is a dialkyl aluminum halide (VI), and the aluminum precatalyst (III) is an aluminum alkoxide mono-halide (XI) according to the general formula:

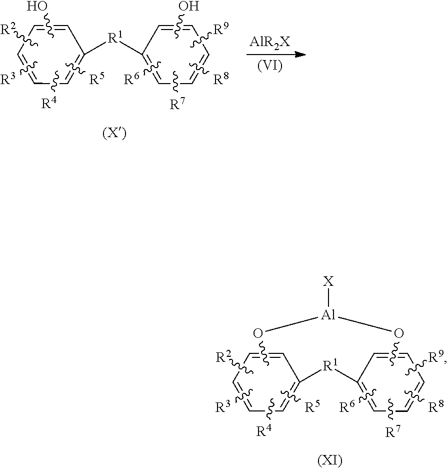

wherein R¹ is a direct bond between the two rings or a divalent hydrocarbyl radical comprising from 1 to 20 atoms selected from Groups 14, 15, and 16 of the periodic table; R² through R⁹ are each independently monovalent hydrocarbyl radicals comprising from 1 to 20 atoms selected from Groups 14, 15, and 16 of the periodic table, or two or more of R² through R⁹ join together to form a ring having 40 or less atoms from Groups 14, 15, and/or 16 of the periodic table.

In one or more embodiments of the invention, the process may further comprise:

i) contacting two equivalents of the aluminum alkoxide mono-halide (XI) with the transition metal halide (IV) to form a transition metal halo bis-alkoxide catalyst precursor (XII) according to the general formula:

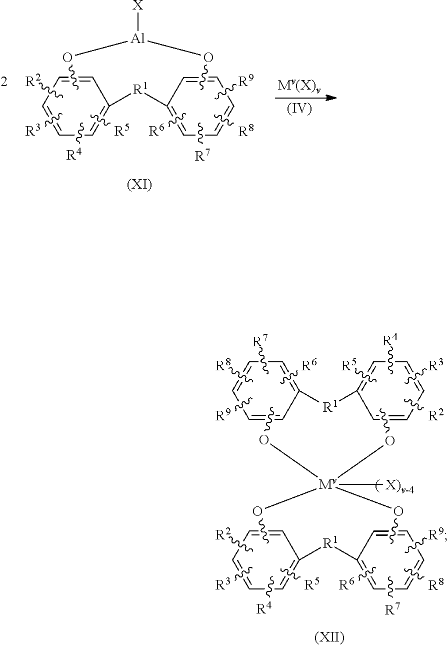

and

ii) contacting the transition metal halo bis-alkoxide catalyst precursor (XII) with a trialkyl aluminum compound (IX) to form the activated carbene containing cyclic olefin polymerization catalyst (XIII) according to the general formula:

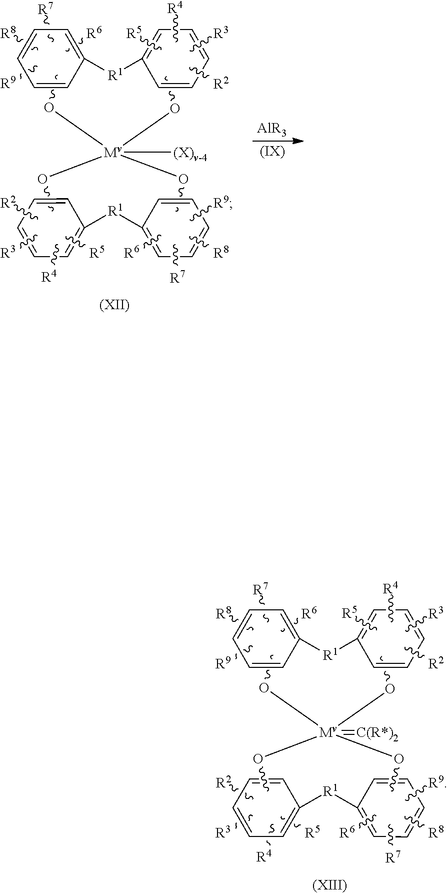

In other embodiments of the invention, the process may further comprise:

i) contacting one equivalent of the aluminum alkoxide mono-halide (XI) with a transition metal halide (IV) to form a transition metal halo alkoxide catalyst precursor (XIV) according to the general formula:

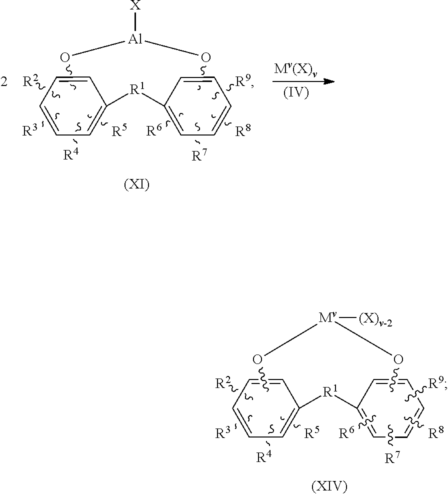

and

ii) contacting the transition metal halo alkoxide catalyst precursor (XIV) with a trialkyl aluminum compound (IX) to form the activated carbene containing cyclic olefin polymerization catalyst (XV) according to the general formula:

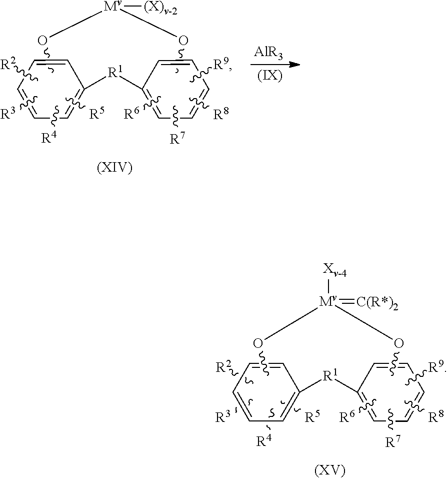

In one or more embodiments of the process, the compound comprising a hydroxyl functional group (I) is a bidentate dihydroxy chelating ligand (X′); the alkyl aluminum compound (II) is a trialkyl aluminum (IX), and the aluminum precatalyst (III) is an alkyl aluminum alkoxide (XX) according to the general formula:

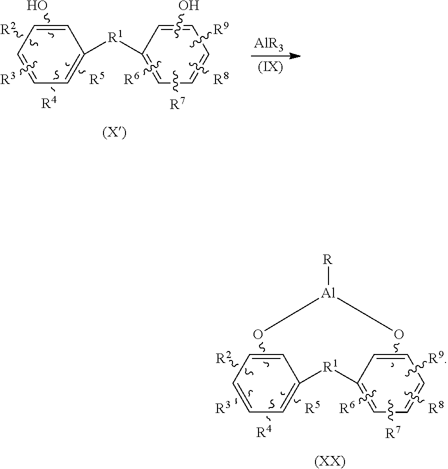

wherein R¹ is a direct bond between the two rings or a divalent hydrocarbyl radical comprising from 1 to 20 atoms selected from Groups 14, 15, and 16 of the periodic table; R² through R⁹ are each independently monovalent hydrocarbyl radicals comprising from 1 to 20 atoms selected from Groups 14, 15, and 16 of the periodic table, or two or more of R² through R⁹ join together for form a ring having 40 or less atoms from Groups 14, 15, and/or 16 of the periodic table.

In embodiments, the process further comprises contacting two equivalents of the aluminum-alkyl alkoxide (XX) with a transition metal halide (V) to form the activated carbene containing cyclic olefin polymerization catalyst (XXI) according to the general formula:

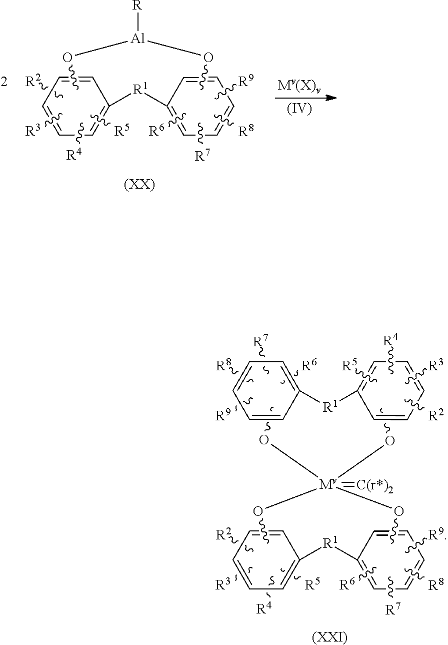

In embodiments of the invention, the process further comprises contacting one equivalent of the aluminum-alkyl alkoxide (XX) with a transition metal halide (V) to form the activated carbene containing cyclic olefin polymerization catalyst (XXIa) according to the general formula:

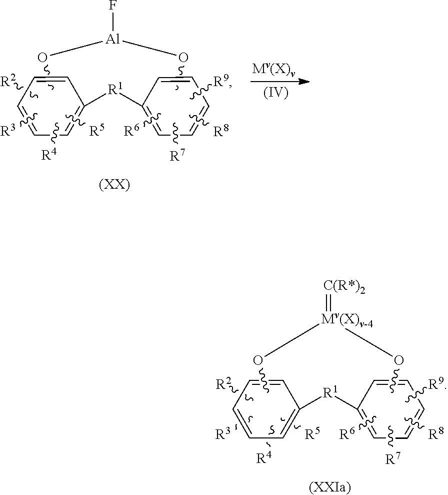

In embodiments of the process, the compound comprising a hydroxyl functional group (I) is a mixture comprising a bidentate dihydroxy chelating ligand (X′) and a monodentate hydroxy ligand (XVI); the alkyl aluminum compound (II) is a trialkyl aluminum (IX), and the aluminum precatalyst (III) is an aluminum tri-alkoxide (XVII), the process further comprising:

i) forming the aluminum tri-alkoxide (XVII) according to the general formula:

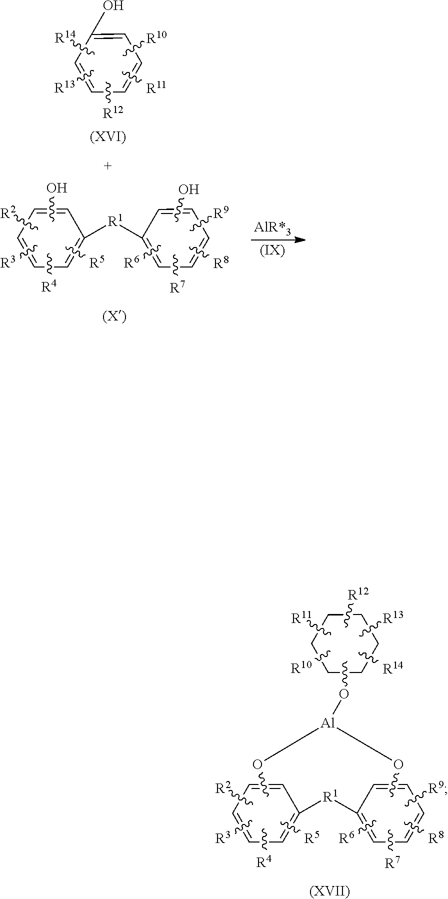

ii) contacting the aluminum tri-alkoxide (XVII) with a transition metal halide (IV) to form a transition metal alkoxide catalyst precursor (XVIII) according to the general formula:

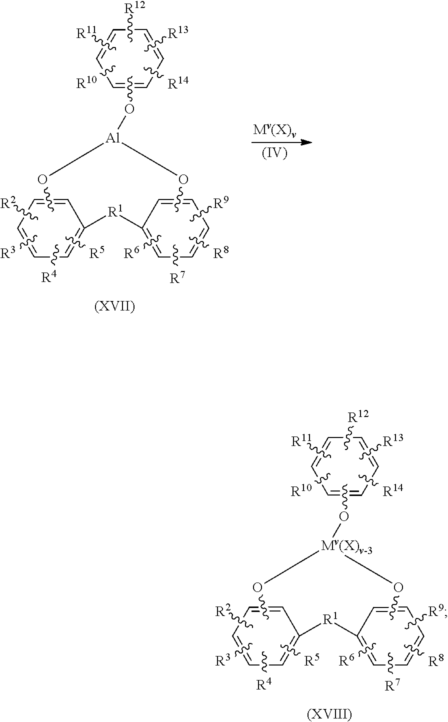

and

iii) contacting the transition metal alkoxide catalyst precursor (XVIII) with a trialkyl aluminum compound (IX) to form the activated carbene containing cyclic olefin polymerization catalyst (XIX) according to the general formula:

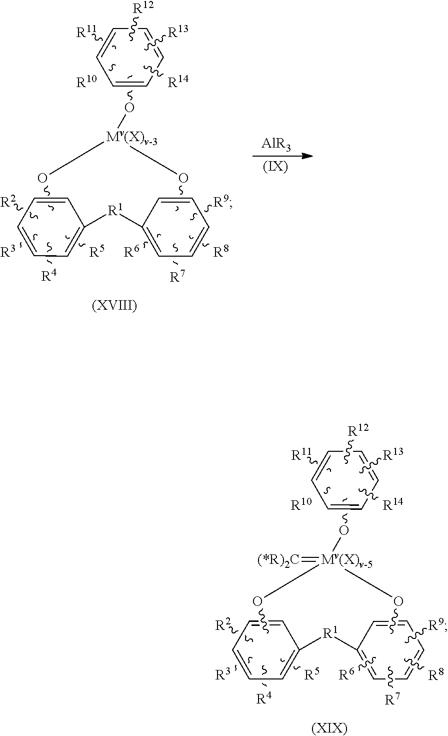

wherein M^{v} is a Group 5 or Group 6 transition metal of valance v; X is halogen; R¹ is a direct bond between the two rings of the bidentate ligand, or a divalent hydrocarbyl radical comprising from 1 to 20 atoms selected from Groups 14, 15, and 16 of the periodic table; each of R² through R¹⁴ is independently, a hydrogen, a monovalent radical comprising from 1 to 20 atoms selected from Groups 14, 15, and 16 of the periodic table, a halogen, or two or more of R² through R⁹ and/or two or more of R¹⁰ through R¹⁴ join together to form a ring comprising 40 atoms or less from Groups 14, 15, and 16 of the periodic table.

In embodiments of the invention, the compound comprising a hydroxyl functional group (I) is an aromatic compound comprising a phenoxy hydroxyl group Ar—OH (XXIV); the alkyl aluminum compound (II) is an alkyl aluminum halide, and the aluminum precatalyst (III) is a mixture of aluminum alkoxides (XXVa), (XXVb), and (XXVc), the process further comprising

i) forming the mixture of aluminum alkoxides (XXVa), (XXVb), and (XXVc) according to the general formula:

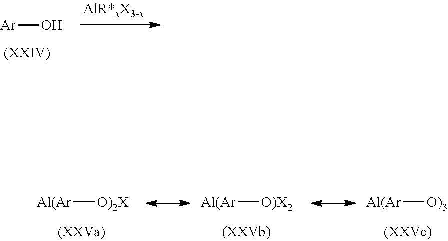

wherein x is from 1 to 2; and

ii) contacting the mixture of metal alkoxides with one or more ligand donors (D) under conditions sufficient to crystalize and isolate the metal alkoxide (IIIa) as one or more dimeric coordinated metal alkoxide-donor composition according to the general structure (XXV-GD₂):

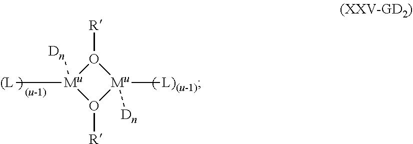

wherein M^{u} is a Group 1, 2, or 13 metal of valance u, preferably Li, Na, Ca, Mg, Al, or Ga;

each R′ is independently a monovalent hydrocarbyl comprising from 1 to 20 atoms selected from Groups 14, 15, and 16 of the periodic table;

each L is R′O—, alkyl R as defined for structure A, or halide X;

each D is any O or N containing organic donor selected from ethers (e.g., dialkyl ethers, cyclic ethers), ketones, amines (e.g., trialkyl amines, aromatic amines, cyclic amines, and heterocyclic amines (e.g., pyridine)), nitriles (e.g., alkyl nitriles and aromatic nitriles), and any combination thereof (preferably, tetrahydrofuran, methyl-tertbutyl ether, a C₁-C₄ dialkyl ether, a C₁-C₄ trialkyl amine, and any combination thereof); and

n is 1, 2, 3, or 4.

Another example of catalysts suitable for use in conjunction with the methods described herein may include, but are not limited to:

(i) a catalyst represented by the (XXVI):

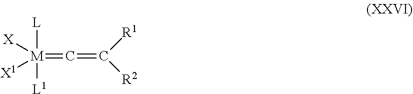

where M is a group 8 metal, preferably Os or Ru, preferably Ru;

X and X¹ are, independently, any anionic ligand, preferably a halogen (preferably chlorine), an alkoxide or a triflate, or X and X¹ may be joined to form a dianionic group and may form a single ring of up to 30 non-hydrogen atoms or a multinuclear-ring system of up to 30 non-hydrogen atoms;

L and L¹ are, independently, a neutral two-electron donor, preferably a phosphine or a N-heterocyclic carbene, L and L¹ may be joined to form a single ring of up to 30 non-hydrogen atoms or a multinuclear-ring system of up to 30 non-hydrogen atoms;

L and X may be joined to form a multidentate monoanionic group and may form a single ring of up to 30 non-hydrogen atoms or a multinuclear-ring system of up to 30 non-hydrogen atoms;

L¹ and X¹ may be joined to form a multidentate monoanionic group and may form a single ring of up to 30 non-hydrogen atoms or a multinuclear-ring system of up to 30 non-hydrogen atoms; and

R¹ and R² may be different or the same and may be hydrogen, substituted or unsubstituted alkyl, or substituted or unsubstituted aryl; and/or

(ii) a catalyst represented by (XXVII):

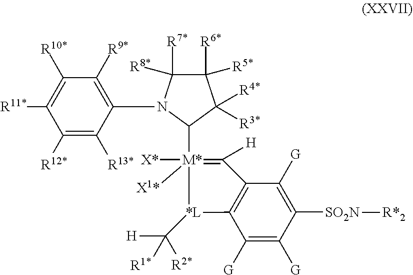

where M* is a Group 8 metal, preferably Ru or Os, preferably Ru;

X* and X1* are, independently, any anionic ligand, preferably a halogen (preferably chlorine), an alkoxide or an alkyl sulfonate, or X* and X1* may be joined to form a dianionic group and may form a single ring of up to 30 non-hydrogen atoms or a multinuclear-ring system of up to 30 non-hydrogen atoms;

L* is N—R**, 0, P—R**, or S, preferably N—R** or O (R** is a C₁ to C₃₀ hydrocarbyl or substituted hydrocarbyl, preferably methyl, ethyl, propyl or butyl);

R* is hydrogen or a C₁ to C₃₀ hydrocarbyl or substituted hydrocarbyl, preferably methyl;

R^{1*}, R^{2*}, R^{3*}, R^{4*}, R^{5*}, R^{6*}, R^{7*}, and R^{8*} are, independently, hydrogen or a C₁ to C₃₀ hydrocarbyl or substituted hydrocarbyl, preferably methyl, ethyl, propyl or butyl, preferably R^{1*}, R^{2*}, R^{3*}, and R^{4*} are methyl;

each R^{9*} and R^{13*} are, independently, hydrogen or a C₁ to C₃₀ hydrocarbyl or substituted hydrocarbyl, preferably a C₂ to C₆ hydrocarbyl, preferably ethyl;

R^{10*}, R^{11*}, R^{12*} are, independently hydrogen or a C₁ to C₃₀ hydrocarbyl or substituted hydrocarbyl, preferably hydrogen or methyl;

each G, is, independently, hydrogen, halogen or C₁ to C₃₀ substituted or unsubstituted hydrocarbyl (preferably a C₁ to C₃₀ substituted or unsubstituted alkyl or a substituted or unsubstituted C₄ to C₃₀ aryl); and

where any two adjacent R groups may form a single ring of up to 8 non-hydrogen atoms or a multinuclear-ring system of up to 30 non-hydrogen atoms; and/or

(iii) a Group 8 metal complex represented by (XXVIII):

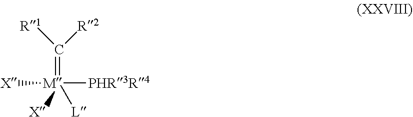

wherein M″ is a Group 8 metal (preferably M is ruthenium or osmium, preferably ruthenium);

each X″ is independently an anionic ligand (preferably selected from the group consisting of halides, alkoxides, aryloxides, and alkyl sulfonates, preferably a halide, preferably chloride);

R″¹ and R″² are independently selected from the group consisting of hydrogen, a C₁ to C₃₀ hydrocarbyl, and a C₁ to C₃₀ substituted hydrocarbyl (preferably R″¹ and R″² are independently selected from the group consisting of methyl, ethyl, propyl, isopropyl, butyl, tert-butyl, sec-butyl, pentyl, cyclopentyl, hexyl, cyclohexyl, heptyl, octyl, cyclooctyl, and substituted analogs and isomers thereof, preferably selected from the group consisting of tert-butyl, sec-butyl, cyclohexyl, and cyclooctyl);

R″³ and R″⁴ are independently selected from the group consisting of hydrogen, C₁ to C₁₂ hydrocarbyl groups, substituted C₁ to C₁₂ hydrocarbyl groups, and halides (preferably R″³ and

R″⁴ are independently selected from the group consisting of methyl, ethyl, propyl, isopropyl, butyl, tert-butyl, sec-butyl, pentyl, cyclopentyl, hexyl, cyclohexyl, heptyl, octyl, cyclooctyl, and substituted analogs and isomers thereof, preferably selected from the group consisting of tert-butyl, sec-butyl, cyclohexyl, and cyclooctyl); and

L″ is a neutral donor ligand, preferably L″ is selected from the group consisting of a phosphine, a sulfonated phosphine, a phosphite, a phosphinite, a phosphonite, an arsine, a stibine, an ether, an amine, an imine, a sulfoxide, a carboxyl, a nitrosyl, a pyridine, a thioester, a cyclic carbene, and substituted analogs thereof, preferably a phosphine, a sulfonated phosphine, an N-heterocyclic carbene, a cyclic alkyl amino carbene, and substituted analogs thereof (preferably L″ is selected from a phosphine, an N-heterocyclic carbene, a cyclic alkyl amino carbene, and substituted analogs thereof); and/or

(iv) a Group 8 metal complex represented by (XXIX):

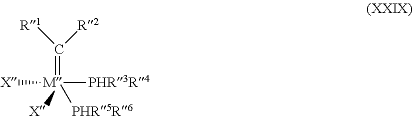

wherein M″ is a Group 8 metal (preferably M is ruthenium or osmium, preferably ruthenium);

each X″ is independently an anionic ligand (preferably selected from the group consisting of halides, alkoxides, aryloxides, and alkyl sulfonates, preferably a halide, preferably chloride);

R″¹ and R″² are independently selected from the group consisting of hydrogen, a C₁ to C₃₀ hydrocarbyl, and a C₁ to C₃₀ substituted hydrocarbyl (preferably R″¹ and R″² are independently selected from the group consisting of methyl, ethyl, propyl, isopropyl, butyl, tert-butyl, sec-butyl, pentyl, cyclopentyl, hexyl, cyclohexyl, heptyl, octyl, cyclooctyl, and substituted analogs and isomers thereof, preferably selected from the group consisting of tert-butyl, sec-butyl, cyclohexyl, and cyclooctyl);

R″³, R″⁴, R″⁵, and R″⁶ are independently selected from the group consisting of hydrogen, C₁ to C₁₂ hydrocarbyl groups, substituted C₁ to C₁₂ hydrocarbyl groups, and halides (preferably R″³, R″⁴, R″⁵, and R″⁶ are independently selected from the group consisting of methyl, ethyl, propyl, isopropyl, butyl, tert-butyl, sec-butyl, pentyl, cyclopentyl, hexyl, cyclohexyl, heptyl, octyl, cyclooctyl, and substituted analogs and isomers thereof, preferably selected from the group consisting of tert-butyl, sec-butyl, cyclohexyl, and cyclooctyl).

Additional examples of catalysts suitable for use in conjunction with the methods described herein are available in U.S. Pat. No. 8,227,371 and US Patent Application Pub. Nos. US 2012/0077945 and US 2019/0040186, each of which is incorporated herein by reference. The catalysts may be zeolite-supported catalysts, silica-supported catalysts, and alumina-supported catalysts.

Two or more catalysts may optionally be used including combinations of the foregoing catalysts.

Optionally, an activator can be included with the catalyst. Examples of activators suitable for use in conjunction with the methods described herein include, but are not limited to, aluminum alkyls (e.g., triethylaluminum), organomagnesium compounds, and the like, and any combination thereof.

The reaction can be carried out as a solution polymerization in a diluent. Diluents for the methods described herein should be non-coordinating, inert liquids. Examples of diluents suitable for use in conjunction with the methods described herein may include, but are not limited to, straight and branched-chain hydrocarbons (e.g., isobutane, butane, pentane, isopentane, hexanes, isohexane, heptane, octane, dodecane, and mixtures thereof); cyclic and alicyclic hydrocarbons (e.g., cyclohexane, cycloheptane, methylcyclohexane, methylcycloheptane, and mixtures thereof such as ISOPAR™ (synthetic isoparaffins, commercially available from ExxonMobil Chemical Company)); perhalogenated hydrocarbons (e.g., perfluorinated C₄-C₁₀ alkanes, chlorobenzene, and aromatic); alkyl substituted aromatic compounds (e.g., benzene, toluene, mesitylene, and xylene); and the like, and any combination thereof.

The reaction mixture can include diluents at 60 vol % or less, or 40 vol % or less, or 20 vol % or less, based on the total volume of the reaction mixture.

Generally, quenching compounds that stop the polymerization reaction are antioxidants, which may be dispersed in alcohols (e.g., methanol or ethanol). Examples of quenching compounds may include, but are not limited to, butylated hydroxytoluene, IRGANOX™ antioxidants (available from BASF), and the like, and any combination thereof.

The quenching compounds can be added to the reaction mixture at 0.05 wt % to 5 wt %, or 0.1 wt % to 2 wt % based on the weight of the polymer product.

In the ROMP process, the preparation of the ROMP catalyst and/or the copolymerization may be carried out in an inert atmosphere (e.g., under a nitrogen or argon environment) to minimize the presence of air and/or water.

Further, the ROMP process may be carried out in a continuous reactor or batch reactors.

LCB-CPRs of the present disclosure may have a mol ratio of first cyclic olefin comonomer-derived units to second cyclic olefin comonomer-derived units of 3:1 to 100:1, or 4:1 to 75:1, or 5:1 to 50:1, or 6:1 to 35:1. As previously discussed, previous methods where the second cyclic olefin comonomer is added in full, the second cyclic olefin comonomer incorporates to a greater degree than the first cyclic olefin comonomer. Accordingly, incorporation of the first cyclic olefin comonomer to a degree greater than a 3:1, 4:1, 5:1, or especially a 6:1 mol ratio of first cyclic olefin comonomer-derived units to second cyclic olefin comonomer-derived units was previously unattainable.

### Styrene-Butadiene Rubber (SBR)

Rubber compounds described herein comprise 30 phr to 60 phr (or 32.5 phr to 57.5 phr, or 35 phr to 55 phr, or 37.5 phr to 52.5 phr, or 40 phr to 50 phr) of a styrene-butadiene rubber (SBR) having a Tg of −60° C. to −5° C. (or −50° C. to −5° C., or −40° C. to −10° C.).

The SBR of the present disclosure may have a Mooney viscosity (ML(1+4) at 100° C.) of 30 MU to 70 MU, or 35 MU to 60 MU, or 40 MU to 50 MU.

The SBR of the present disclosure may have a vinyl content of 10 mol % to 75 mol %, or 15 mol % to 70 mol %, or 20 mol % to 65 mol %, preferably 45 mol % to 65 mol %.

The SBR of the present disclosure may have a bonded styrene content of 15 wt % to 45 wt %, or 20 wt % to 35 wt %, based on the total weight percent of the SBR.

The SBR may be used as a solution polymerized SBR or as an emulsion polymerized SBR when produced by solution polymerization, or emulsion polymerization, respectively. Solution polymerized SBR is preferred.

A suitable example of SBR may include NIPOL® SBR (manufactured by Nippon Zeon Corporation). For example, NIPOL® NS116R can be used in the rubber compound and has bonded styrene content of 21.0 wt %, a vinyl content of 63.8%, a Mooney viscosity at 100° C. of 45 MU, and/or a Tg of −30° C. The bonded styrene content of the butadiene moiety of the styrene-butadiene copolymer component can be measured by ¹H NMR.

Rubber compounds described herein can comprise a single SBR or a mixture of two or more SBRs, it being possible for the SBR to be used in combination with any type of synthetic elastomer other than an SBR, indeed even with polymers other than elastomers, for example thermoplastic polymers.

### Tire Tread Compositions

Passenger car tire treads can comprise rubber compounds described herein that comprise: 40 phr to 70 phr (or 42.5 phr to 67.5 phr, or 45 phr to 65 phr, or 47.5 phr to 62.5 phr, or 50 phr to 60 phr) of a long chain branched cyclopentene ring-opening rubber (LCB-CPR) having a glass transition temperature (Tg) of −120° C. to −80° C. (or −110° C. to −85° C., or −100° C. to −90° C.), a g′ᵥᵢₛ of 0.50 to 0.91 (or 0.50 to 0.8, or 0.60 to 0.8, or 0.70 to 0.91), and a ratio of cis to trans of 40:60 to 5:95 (30:70 to 10:90, or 20:80 to 10:90, or 15:85); 30 phr to 60 phr (or 32.5 phr to 57.5 phr, or 35 phr to 55 phr, or 37.5 phr to 52.5 phr, or 40 phr to 50 phr) of a styrene-butadiene rubber (SBR) having a Tg of −60° C. to −5° C. (or −50° C. to −5° C., or −40° C. to −10° C.); 50 phr to 110 phr (or 70 phr to 90 phr, or 73 phr to 87 phr, or 76 phr to 84 phr, or 78 phr to 82 phr) of a reinforcing filler; 20 phr to 50 phr (or 22 phr to 48 phr, or 24 phr to 46 phr, or 26 phr to 44 phr, or 28 phr to 42 phr, or 30 phr to 40 phr) of a process oil; and optionally additional additives.

To form the rubber compounds in accordance with at least one embodiment of the present disclosure, the rubber compounds may be compounded or otherwise mixed according to suitable mixing methods; and molded into tire treads, wherein crosslinking and/or curing occurs per known methods and at known points during the method of forming the tire tread and/or related rubber compound.

### Example Embodiments and Clauses

A nonlimiting example embodiment of the present invention is a rubber compound for passenger tires comprising: 40 to 70 parts by weight per hundred parts by weight rubber (phr) of a long chain branched cyclopentene ring-opening rubber (LCB-CPR) having a glass transition temperature (Tg) of −120° C. to −80° C., a g′ᵥᵢₛ of 0.50 to 0.91, and a ratio of cis to trans of 40:60 to 5:95, 30 phr to 60 phr of a styrene-butadiene rubber (SBR), wherein the SBR has a glass transition temperature (Tg) of −60° C. to −5° C., 50 phr to 110 phr of a reinforcing filler, and 20 phr to 50 phr of a process oil. The rubber compound may include one or more of the following: Element 1: wherein the LCB-CPR has a weight average molecular weight (Mw) of 1 kDa to 1,000 kDa; Element 2: wherein the LCB-CPR has a number average molecular weight (Mn) of 0.5 kDa to 500 kDa; Element 3: wherein the long chain branched cyclopentene ring-opening rubber (CPR) has a Mw divided by Mn of 1 to 10; Element 4: wherein the LCB-CPR has a melting temperature of 10° C. to 20° C.; Element 5: wherein the SBR has a Mooney viscosity (ML(1+4) at 100° C.) of 40 MU to 50 MU; Element 6: wherein the reinforcing filler comprises carbon black, silica, or a mixture thereof, Element 7: wherein the rubber compound has a cross-linking density (MH-ML) after curing at 160° C., 0.50 for 45 minutes of 10 dN.M to 25 dN; Element 8: wherein the rubber compound has a wet skid resistance (tan δ at −8° C., strain at 0.20%) of 0.1 to 0.7; Element 9: wherein the rubber compound has a wear loss (tan δ at 60° C., strain at 2.0%) of 0.1 to 0.45; Element 10: wherein the rubber compound has a tire handling (G′ at 60° C., strain at 2.0%) of 4 MPa to 10 MPa; Element 11: wherein the rubber compound has a DIN abrasion volume loss of 40 mm³ to 130 mm³; Element 12: the rubber compound further comprising: 0.1 phr to 15 phr of a vulcanizing agent and/or a crosslinking agent; and Element 13: wherein the rubber compound is at least partially crosslinked.

Another nonlimiting example embodiment of the present invention is a method comprising: compounding: 40 to 70 parts by weight per hundred parts by weight rubber (phr) of a long chain branched cyclopentene ring-opening rubber (LCB-CPR) having a glass transition temperature (Tg) of −120° C. to −80° C., a g′ᵥᵢₛ of 0.50 to 0.91, and a ratio of cis to trans of 40:60 to 5:95; 30 phr to 60 phr of a styrene-butadiene rubber (SBR), wherein the SBR has a glass transition temperature (Tg) of −60° C. to −5° C.; 50 phr to 110 phr of a reinforcing filler; and 20 phr to 50 phr of a process oil to form a rubber compound. The method and/or rubber compound may include one or more of the following: Element 1; Element 2; Element 3; Element 4; Element 5; Element 6; Element 7; Element 8; Element 9; Element 10; Element 11; Element 12; and Element 14: Element 12 and the method further comprising: molding the rubber compound into a passenger tire tread.

Another nonlimiting example embodiment of the present invention is a passenger tire tread comprising: a rubber compound that comprises: 40 to 70 parts by weight per hundred parts by weight rubber (phr) of a long chain branched cyclopentene ring-opening rubber (LCB-CPR) having a glass transition temperature (Tg) of −120° C. to −80° C., a g′ᵥᵢₛ of 0.50 to 0.91, and a ratio of cis to trans of 40:60 to 5:95, 30 phr to 60 phr of a styrene-butadiene rubber (SBR), wherein the SBR has a glass transition temperature (Tg) of −60° C. to −5° C., 50 phr to 110 phr of a reinforcing filler, and 20 phr to 50 phr of a process oil. The passenger tire tread and/or rubber compound may include one or more of the following: Element 1; Element 2; Element 3; Element 4; Element 5; Element 6; Element 7; Element 8; Element 9; Element 10; Element 11; Element 12; Element 13; and Element 15: wherein the tire tread has a depth of 15/32 of an inch or less.

Clause 1. A rubber compound for passenger tires comprising: 40 to 70 parts by weight per hundred parts by weight rubber (phr) (or 42.5 phr to 67.5 phr, or 45 phr to 65 phr, or 47.5 phr to 62.5 phr, or 50 phr to 60 phr) of a long chain branched cyclopentene ring-opening rubber (LCB-CPR) having a glass transition temperature (Tg) of −120° C. to −80° C. (or −110° C. to −85° C., or −100° C. to −90° C.), a g′ᵥᵢₛ of 0.50 to 0.91 (or 0.50 to 0.8, or 0.60 to 0.8, or 0.70 to 0.91), and a ratio of cis to trans of 40:60 to 5:95 (30:70 to 10:90, or 20:80 to 10:90, or 15:85); 30 phr to 60 phr (or 32.5 phr to 57.5 phr, or 35 phr to 55 phr, or 37.5 phr to 52.5 phr, or 40 phr to 50 phr) of a styrene-butadiene rubber (SBR) having a Tg of −60° C. to −5° C. (or −50° C. to −5° C., or −40° C. to −10° C.); 50 phr to 110 phr (or 70 phr to 90 phr, or 73 phr to 87 phr, or 76 phr to 84 phr, or 78 phr to 82 phr) of a reinforcing filler; and 20 phr to 50 phr (or 22 phr to 48 phr, or 24 phr to 46 phr, or 26 phr to 44 phr, or 28 phr to 42 phr, or 30 phr to 40 phr) of a process oil.

Clause 2. The rubber compound of Clause 1, wherein the LCB-CPR has a weight average molecular weight (Mw) of 1 kDa to 1,000 kDa (or 10 kDa to 1,000 kDa, or 100 kDa to 1,000 kDa, or 250 kDa to 750 kDa, or 250 kDa to 550 kDa).

Clause 3. The rubber compound of Clause 1 or Clause 2, wherein the LCB-CPR has a number average molecular weight (Mn) of 0.5 kDa to 500 kDa (or 1 kDa to 250 kDa, or 10 kDa to 250 kDa, or 50 kDa to 250 kDa, or 100 kDa to 500 kDa).

Clause 4. The rubber compound of Clause 1 or Clause 2 or Clause 3, wherein the long chain branched cyclopentene ring-opening rubber (CPR) has a Mw divided by Mn of 1 to 10 (1 to 10, or greater than 1 to 10, or 1 to 5, or greater than 1 to 5 or 2 to 4, or 1 to 3, or greater than 1 to 3).

Clause 5. The rubber compound of Clause 1 or Clause 2 or Clause 3 or Clause 4, wherein the LCB-CPR has a melting temperature of 10° C. to 20° C.

Clause 6. The rubber compound of Clause 1 or Clause 2 or Clause 3 or Clause 4 or Clause 5, wherein the SBR has a Mooney viscosity (ML(1+4) at 100° C.) of 40 MU to 50 MU.

Clause 7. The rubber compound of Clause 1 or Clause 2 or Clause 3 or Clause 4 or Clause 5 or Clause 6, wherein the reinforcing filler comprises carbon black, silica, or a mixture thereof.

Clause 8. The rubber compound of Clause 1 or Clause 2 or Clause 3 or Clause 4 or Clause 5 or Clause 6 or Clause 7, wherein the rubber compound has a cross-linking density (MH-ML) after curing at 160° C., 0.5° for 45 minutes of 10 dN.M to 25 dN.M (or 12.5 dN.M to 22.5 dN.M, or 13 dN.M to 20 dN.M).

Clause 9. The rubber compound of Clause 1 or Clause 2 or Clause 3 or Clause 4 or Clause 5 or Clause 6 or Clause 7 or Clause 8, wherein the rubber compound has a wet skid resistance (tan δ at −8° C., strain at 0.20%) of 0.1 to 0.7 (or 0.15 to 0.6, or 0.2 to 0.5).

Clause 10. The rubber compound of Clause 1 or Clause 2 or Clause 3 or Clause 4 or Clause 5 or Clause 6 or Clause 7 or Clause 8 or Clause 9, wherein the rubber compound has a wear loss (tan δ at 60° C., strain at 2.0%) of 0.1 to 0.45 (or 0.12 to 0.4, or 0.15 to 0.35, or 0.17 to 0.30).

Clause 11. The rubber compound of Clause 1 or Clause 2 or Clause 3 or Clause 4 or Clause 5 or Clause 6 or Clause 7 or Clause 8 or Clause 9 or Clause 10, wherein the rubber compound has a tire handling (G′ at 60° C., strain at 2.0%) of 4 MPa to 10 MPa (or 5 MPa to 9 MPa, or 6 MPa to 8 MPa).

Clause 12. The rubber compound of Clause 1 or Clause 2 or Clause 3 or Clause 4 or Clause 5 or Clause 6 or Clause 7 or Clause 8 or Clause 9 or Clause 10 or Clause 11, wherein the rubber compound has a DIN abrasion volume loss of 40 mm³ to 130 mm³ (or 50 mm³ to 120 mm³, or 60 mm³ to 110 mm³).

Clause 13. The rubber compound of Clause 1 or Clause 2 or Clause 3 or Clause 4 or Clause 5 or Clause 6 or Clause 7 or Clause 8 or Clause 9 or Clause 10 or Clause 11 or Clause 12 further comprising: 0.1 phr to 15 phr (or 1 phr to 5 phr, or 2 phr to 4 phr) of a vulcanizing agent and/or a crosslinking agent.

Clause 14. The rubber compound of Clause 1 or Clause 2 or Clause 3 or Clause 4 or Clause 5 or Clause 6 or Clause 7 or Clause 8 or Clause 9 or Clause 10 or Clause 11 or Clause 12 or Clause 13, wherein the rubber compound is at least partially crosslinked.

Clause 15. A method comprising: compounding: 40 to 70 parts by weight per hundred parts by weight rubber (phr) (or 42.5 phr to 67.5 phr, or 45 phr to 65 phr, or 47.5 phr to 62.5 phr, or 50 phr to 60 phr) of a long chain branched cyclopentene ring-opening rubber (LCB-CPR) having a glass transition temperature (Tg) of −120° C. to −80° C. (or −110° C. to −85° C., or −100° C. to −90° C.), a g′ᵥᵢₛ of 0.50 to 0.91 (or 0.50 to 0.8, or 0.60 to 0.8, or 0.70 to 0.91), and a ratio of cis to trans of 40:60 to 5:95 (30:70 to 10:90, or 20:80 to 10:90, or 15:85); 30 phr to 60 phr (or 32.5 phr to 57.5 phr, or 35 phr to 55 phr, or 37.5 phr to 52.5 phr, or 40 phr to 50 phr) of a styrene-butadiene rubber (SBR) having a Tg of −60° C. to −5° C. (or −50° C. to −5° C., or −40° C. to −10° C.); 50 phr to 110 phr (or 70 phr to 90 phr, or 73 phr to 87 phr, or 76 phr to 84 phr, or 78 phr to 82 phr) of a reinforcing filler; and 20 phr to 50 phr (or 22 phr to 48 phr, or 24 phr to 46 phr, or 26 phr to 44 phr, or 28 phr to 42 phr, or 30 phr to 40 phr) of a process oil to form a rubber compound.

Clause 16. The method of Clause 15, wherein the rubber compound further comprises 0.1 phr to 15 phr (or 1 phr to 5 phr, or 2 phr to 4 phr) of a vulcanizing agent and/or a crosslinking agent, and wherein the method further comprises: at least partially crosslinking the rubber compound.

Clause 17. The method of any of Clause 15 or Clause 16 further comprising: molding the rubber compound into a passenger tire tread.

Clause 18. A passenger tire tread comprising: a rubber compound that comprises: 40 to 70 parts by weight per hundred parts by weight rubber (phr) (or 42.5 phr to 67.5 phr, or 45 phr to 65 phr, or 47.5 phr to 62.5 phr, or 50 phr to 60 phr) of a long chain branched cyclopentene ring-opening rubber (LCB-CPR) having a glass transition temperature (Tg) of −120° C. to −80° C. (or −110° C. to −85° C., or −100° C. to −90° C.), a g′ᵥᵢₛ of 0.50 to 0.91 (or 0.50 to 0.8, or 0.60 to 0.8, or 0.70 to 0.91), and a ratio of cis to trans of 40:60 to 5:95 (30:70 to 10:90, or 20:80 to 10:90, or 15:85); 30 phr to 60 phr (or 32.5 phr to 57.5 phr, or 35 phr to 55 phr, or 37.5 phr to 52.5 phr, or 40 phr to 50 phr) of a styrene-butadiene rubber (SBR) having a Tg of −60° C. to −5° C. (or −50° C. to −5° C., or −40° C. to −10° C.); 50 phr to 110 phr (or 70 phr to 90 phr, or 73 phr to 87 phr, or 76 phr to 84 phr, or 78 phr to 82 phr) of a reinforcing filler; and 20 phr to 50 phr (or 22 phr to 48 phr, or 24 phr to 46 phr, or 26 phr to 44 phr, or 28 phr to 42 phr, or 30 phr to 40 phr) of a process oil.

Clause 19. The passenger tire tread of Clause 18, wherein the rubber compound is at least partially crosslinked.

Clause 20. The passenger tire tread of Clause 18 or Clause 19, wherein the tire tread has a depth of 15/32 inches or less (or 2/32 inches or greater, or 3/32 inches to 15/32 inches, or 9/32 inches to 12/32 inches).

The present invention includes a rubber compound for passenger tires comprising:

40 to 70 parts by weight per hundred parts by weight rubber (phr) (or 42.5 phr to 67.5 phr, or 45 phr to 65 phr, or 47.5 phr to 62.5 phr, or 50 phr to 60 phr) of a long chain branched cyclopentene ring-opening rubber (LCB-CPR) having a glass transition temperature (Tg) of −120° C. to −80° C. (or −110° C. to −85° C., or −100° C. to −90° C.), a g′ᵥᵢₛ of 0.50 to 0.91 (or 0.50 to 0.8, or 0.60 to 0.8, or 0.70 to 0.91), a ratio of cis to trans of 40:60 to 5:95 (30:70 to 10:90, or 20:80 to 10:90, or 15:85); a weight average molecular weight (Mw) of 1 kDa to 1,000 kDa (or 10 kDa to 1,000 kDa, or 100 kDa to 1,000 kDa, or 250 kDa to 750 kDa, or 250 kDa to 550 kDa); a number average molecular weight (Mn) of 0.5 kDa to 500 kDa (or 1 kDa to 250 kDa, or 10 kDa to 250 kDa, or 50 kDa to 250 kDa, or 100 kDa to 500 kDa); a Mw divided by Mn of 1 to 10 (1 to 10, or greater than 1 to 10, or 1 to 5, or greater than 1 to 5 or 2 to 4, or 1 to 3, or greater than 1 to 3), and/or a melting temperature of 10° C. to 20° C.;

30 phr to 60 phr (or 32.5 phr to 57.5 phr, or 35 phr to 55 phr, or 37.5 phr to 52.5 phr, or 40 phr to 50 phr) of a styrene-butadiene rubber (SBR) having a Tg of −60° C. to −5° C. (or −50° C. to −5° C., or −40° C. to −10° C.) and/or a Mooney viscosity (ML(1+4) at 100° C.) of 40 MU to 50 MU;

50 phr to 110 phr (or 70 phr to 90 phr, or 73 phr to 87 phr, or 76 phr to 84 phr, or 78 phr to 82 phr) of a reinforcing filler (e.g., carbon black, silica, or a mixture thereof);

20 phr to 50 phr (or 22 phr to 48 phr, or 24 phr to 46 phr, or 26 phr to 44 phr, or 28 phr to 42 phr, or 30 phr to 40 phr) of a process oil; and

optionally 0.1 phr to 15 phr (or 1 phr to 5 phr, or 2 phr to 4 phr) of a vulcanizing agent and/or a crosslinking agent (when included, the rubber compound may be at least partially crosslinked); and

wherein the rubber compound has a cross-linking density (MH-ML) after curing at 160° C., 0.5° for 45 minutes of 10 dN.M to 25 dN.M (or 12.5 dN.M to 22.5 dN.M, or 13 dN.M to 20 dN.M); a wet skid resistance (tan δ at −8° C., strain at 0.20%) of 0.1 to 0.7 (or 0.15 to 0.6, or 0.2 to 0.5); a wear loss (tan δ at 60° C., strain at 2.0%) of 0.1 to 0.45 (or 0.12 to 0.4, or 0.15 to 0.35, or 0.17 to 0.30); a tire handling (G′ at 60° C., strain at 2.0%) of 4 MPa to 10 MPa (or 5 MPa to 9 MPa, or 6 MPa to 8 MPa); and/or a DIN abrasion volume loss of 40 mm³ to 130 mm³ (or 50 mm³ to 120 mm³, or 60 mm³ to 110 mm³).

The present invention also includes a method comprising:

compounding:

40 to 70 parts by weight per hundred parts by weight rubber (phr) (or 42.5 phr to 67.5 phr, or 45 phr to 65 phr, or 47.5 phr to 62.5 phr, or 50 phr to 60 phr) of a long chain branched cyclopentene ring-opening rubber (LCB-CPR) having a glass transition temperature (Tg) of −120° C. to −80° C. (or −110° C. to −85° C., or −100° C. to −90° C.), a g′ᵥᵢₛ of 0.50 to 0.91 (or 0.50 to 0.8, or 0.60 to 0.8, or 0.70 to 0.91), a ratio of cis-to-trans of 40:60 to 5:95 (30:70 to 10:90, or 20:80 to 10:90, or 15:85); a weight average molecular weight (Mw) of 1 kDa to 1,000 kDa (or 10 kDa to 1,000 kDa, or 100 kDa to 1,000 kDa, or 250 kDa to 750 kDa, or 250 kDa to 550 kDa); a number average molecular weight (Mn) of 0.5 kDa to 500 kDa (or 1 kDa to 250 kDa, or 10 kDa to 250 kDa, or 50 kDa to 250 kDa, or 100 kDa to 500 kDa); a Mw divided by Mn of 1 to 10 (1 to 10, or greater than 1 to 10, or 1 to 5, or greater than 1 to 5 or 2 to 4, or 1 to 3, or greater than 1 to 3), and/or a melting temperature of 10° C. to 20° C.;

30 phr to 60 phr (or 32.5 phr to 57.5 phr, or 35 phr to 55 phr, or 37.5 phr to 52.5 phr, or 40 phr to 50 phr) of a styrene-butadiene rubber (SBR) having a Tg of −60° C. to −5° C. (or −50° C. to −5° C., or −40° C. to −10° C.) and/or a Mooney viscosity (ML(1+4) at 100° C.) of 40 MU to 50 MU;

50 phr to 110 phr (or 70 phr to 90 phr, or 73 phr to 87 phr, or 76 phr to 84 phr, or 78 phr to 82 phr) of a reinforcing filler (e.g., carbon black, silica, or a mixture thereof);

20 phr to 50 phr (or 22 phr to 48 phr, or 24 phr to 46 phr, or 26 phr to 44 phr, or 28 phr to 42 phr, or 30 phr to 40 phr) of a process oil; and

optionally 0.1 phr to 15 phr (or 1 phr to 5 phr, or 2 phr to 4 phr) of a vulcanizing agent and/or a crosslinking agent (when included, the method may further include at least partially crosslinking the rubber compound); and

wherein the rubber compound has a cross-linking density (MH-ML) after curing at 160° C., 0.5° for 45 minutes of 10 dN.M to 25 dN.M (or 12.5 dN.M to 22.5 dN.M, or 13 dN.M to 20 dN.M); a wet skid resistance (tan δ at −8° C., strain at 0.20%) of 0.1 to 0.7 (or 0.15 to 0.6, or 0.2 to 0.5); a wear loss (tan δ at 60° C., strain at 2.0%) of 0.1 to 0.45 (or 0.12 to 0.4, or 0.15 to 0.35, or 0.17 to 0.30); a tire handling (G′ at 60° C., strain at 2.0%) of 4 MPa to 10 MPa (or 5 MPa to 9 MPa, or 6 MPa to 8 MPa); and/or a DIN abrasion volume loss of 40 mm³ to 130 mm³ (or 50 mm³ to 120 mm³, or 60 mm³ to 110 mm³).

The foregoing method may further comprise: molding the rubber compound into a passenger tire tread, where the tire tread may have a depth of 15/32 inches or less (or 2/32 inches or greater, or 3/32 inches to 15/32 inches, or 9/32 inches to 12/32 inches).

The present invention also includes a passenger tire tread comprising: a rubber compound that comprises:

40 to 70 parts by weight per hundred parts by weight rubber (phr) (or 42.5 phr to 67.5 phr, or 45 phr to 65 phr, or 47.5 phr to 62.5 phr, or 50 phr to 60 phr) of a long chain branched cyclopentene ring-opening rubber (LCB-CPR) having a glass transition temperature (Tg) of −120° C. to −80° C. (or −110° C. to −85° C., or −100° C. to −90° C.), a g′ᵥᵢₛ of 0.50 to 0.91 (or 0.50 to 0.8, or 0.60 to 0.8, or 0.70 to 0.91), a ratio of cis-to-trans of 40:60 to 5:95 (30:70 to 10:90, or 20:80 to 10:90, or 15:85); a weight average molecular weight (Mw) of 1 kDa to 1,000 kDa (or 10 kDa to 1,000 kDa, or 100 kDa to 1,000 kDa, or 250 kDa to 750 kDa, or 250 kDa to 550 kDa); a number average molecular weight (Mn) of 0.5 kDa to 500 kDa (or 1 kDa to 250 kDa, or 10 kDa to 250 kDa, or 50 kDa to 250 kDa, or 100 kDa to 500 kDa); a Mw divided by Mn of 1 to 10 (1 to 10, or greater than 1 to 10, or 1 to 5, or greater than 1 to 5 or 2 to 4, or 1 to 3, or greater than 1 to 3), and/or a melting temperature of 10° C. to 20° C.;

30 phr to 60 phr (or 32.5 phr to 57.5 phr, or 35 phr to 55 phr, or 37.5 phr to 52.5 phr, or 40 phr to 50 phr) of a styrene-butadiene rubber (SBR) having a Tg of −60° C. to −5° C. (or −50° C. to −5° C., or −40° C. to −10° C.) and/or a Mooney viscosity (ML(1+4) at 100° C.) of 40 MU to 50 MU;

50 phr to 110 phr (or 70 phr to 90 phr, or 73 phr to 87 phr, or 76 phr to 84 phr, or 78 phr to 82 phr) of a reinforcing filler (e.g., carbon black, silica, or a mixture thereof);

20 phr to 50 phr (or 22 phr to 48 phr, or 24 phr to 46 phr, or 26 phr to 44 phr, or 28 phr to 42 phr, or 30 phr to 40 phr) of a process oil; and

optionally 0.1 phr to 15 phr (or 1 phr to 5 phr, or 2 phr to 4 phr) of a vulcanizing agent and/or a crosslinking agent (when included, the rubber compound may be at least partially crosslinked); and

wherein the rubber compound has a cross-linking density (MH-ML) after curing at 160° C., 0.5° for 45 minutes of 10 dN.M to 25 dN.M (or 12.5 dN.M to 22.5 dN.M, or 13 dN.M to 20 dN.M); a wet skid resistance (tan δ at −8° C., strain at 0.20%) of 0.1 to 0.7 (or 0.15 to 0.6, or 0.2 to 0.5); a wear loss (tan δ at 60° C., strain at 2.0%) of 0.1 to 0.45 (or 0.12 to 0.4, or 0.15 to 0.35, or 0.17 to 0.30); a tire handling (G′ at 60° C., strain at 2.0%) of 4 MPa to 10 MPa (or 5 MPa to 9 MPa, or 6 MPa to 8 MPa); and/or a DIN abrasion volume loss of 40 mm³ to 130 mm³ (or 50 mm³ to 120 mm³, or 60 mm³ to 110 mm³); and

wherein the tire tread has a depth of 15/32 inches or less (or 2/32 inches or greater, or 3/32 inches to 15/32 inches, or 9/32 inches to 12/32 inches).

In embodiments of the invention the rubber compound has a tensile stress at 300% elongation (300% Modulus) at room temperature less than that of a heavy duty truck tire, (e.g., less than 10 MPa, alternately less than 9 MPa).

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

To facilitate a better understanding of the embodiments of the present invention, the following examples of preferred or representative embodiments are given. In no way should the following examples be read to limit, or to define, the scope of the invention.

### Examples

Commercial cyclopentene (cC5) was purified by passing through the column with activated basic alumina. Commercial styrene-butadiene rubber (SBR) NIPOL® NS116R was used. Commercial polybutadiene rubber (BR) NEODYMIUM HIGH-CIS DIENE™ 140ND was purchased from used.

N234 type carbon black is a reinforcing filler. ZEOSIL™ 1165MP silica is a highly dispersible reinforcing filler silica. Silane X 50-S® is a blend of a bi-functional sulfur-containing organosilane Si 69® (bis(triethoxysilylpropyl)tetrasulfide)) and an N330 type carbon black in the ratio 1:1 by weight. SUNDEX® 8125 aromatic processing oil. NOCHEK® 4756A is a wax antiozonant. SANTOFLEX® 6PPD is an antioxidant. KADOX® 911 is a zinc oxide reinforcing agent of high surface area used as a crosslinker, accelerator, and initiator. DPG is diphenyl guanidine, used as an accelerator/activator. CBS is n-cyclohexyl-2-benzothiazole sulfonamide, used as a delayed action accelerator (medium to fast primary accelerator).

The long chain branched cyclopentene ring-opening rubber (CPR) was produced as follows:

At room temperature, to a beaker equipped with a magnetic stirrer and contained within an inert atmosphere glove box, were charged 0.793 g (2.00 mmol) of WCl₆ and about 25 mL of toluene. Next, 1.331 g (4.00 mmol) of (2-iPrPhO)₂AlCl was added, and the resulting mixture was stirred for 2.5 hours at room temperature. Meanwhile, to a 4 L kettle reactor contained within an inert atmosphere glove box and fitted with a mechanical stirrer, 600 g of purified cC5 (previously treated by passing through a column packed with basic alumina) and 3.6 L of anhydrous toluene were added. The reaction kettle and the contents were chilled to 0° C. using an external thermostatic bath. With vigorous stirring, the catalyst solution described above was added to the kettle charge. The reaction was quenched at 8.3 hours, due to high viscosity, by the addition of a BHT solution prepared from 0.880 g of anhydrous BHT, 130 mL of anhydrous MeOH, and 260 mL of anhydrous toluene. The high-viscosity, gel-like reaction mixture was then precipitated into a stirred MeOH solvent (about 8 L). The resulting polymer was spread onto an aluminum foil in a fume hood, misted with a solution of BHT/MeOH (about 2 g of BHT), and was allowed to dry for 3 days. An additional drying in a vacuum oven at 50° C. for 14 hours was also applied.

According to the GPC testing, the resulting long chain branched CPR was obtained with a Mw of 349 kg/mol, a molecular weight distribution (Mw divided by Mn) of 2. According to the ¹³C NMR testing, the resulting long chain branched CPR was obtained with a cis:trans ratio of 15/85. According to the DSC testing, the resulting long chain branched CPR was obtained with a Tg of −97° C. and a peak melting temperature Tm of 15° C.

The rubber compounding was performed as follows:

All tire tread compounds were prepared in a BARBENDER™ mixer. All carbon black-filled compositions (Samples 1-11) went through two stages of mixing. All silica-filled compositions (Samples 12-15) went through three stages of mixing. After mixing, each composition was tested for cure behavior with a dynamic mechanical analyzer ATD™ 1000 (from Alpha Technologies). The testing was carried out at 160° C. for 45 minutes (at 1.67 Hz and 7.0% strain). Samples 1-6 and Samples 11-14 were used as comparative examples, with Samples 1-5 including a blend of SBR/cis-BR and filled with carbon black, Samples 6 and 11 including a blend of SBR/LCB-CPR and filled with carbon black, Samples 12-14 including a blend of SBR/cis-BR and filled with silica, and Sample 15 including a blend of SBR/LCB-CPR and filled with silica.

For each sample, one tensile pad (3.0 inch by 6.0 inch, about 2.0 mm in thickness) was cured under high pressure in a mold heated at 160° C. for tc₉₀+2 min. Here, the cure time tc₉₀ was from the cure test for the corresponding compound.

Samples were die-cut out from the tensile pad for both dynamic temperature ramp testing with an Advanced Rheometric Expansion System (ARES™) from Rheometric Scientific, Inc., and tensile testing at room temperature. A rectangular strip was die-cut out of the cured tensile pad for dynamic temperature ramp testing at 10 Hz and at the heating rate of 2° C./min with an Advanced Rheometric Expansion System (ARES™) from Rheometric Scientific, Inc. Such testing employed a torsional rectangular geometry. The strain amplitude was at 0.20% below 0° C. while it was raised to 2.0% at and above 0° C. Six data points were collected per minute, and all tests ended at 80° C.

### Carbon Black-Filled Model Passenger Tire Tread Compounds (Tables 1-3, FIGS. 1-3).

The foregoing reactions and results of the foregoing reactions are summarized in Table 1. The formulations of the samples (Samples 1-11), including the inventive compositions comprising a blend of SBR/LCB-CPR (Samples 7-10, 40 phr to 70 phr of LCB-CPR), are displayed in Table I.

TABLE 1

| Samples | | | | | | | | | | |
|---|---|---|---|---|---|---|---|---|---|---|
| 1 | 2 | 3 | 4 | 5 | 6 | 7 | 8 | 9 | 10 | 11 |

Master Batch

| | | | | | | | | | | | |
|---|---|---|---|---|---|---|---|---|---|---|---|
| SBR NIPOL ® | 70 | 60 | 50 | 40 | 30 | 70 | 60 | 50 | 40 | 30 | 20 |
| NS116R (phr) | | | | | | | | | | | |
| Cis-BR | 30 | 40 | 50 | 60 | 70 | 0 | 0 | 0 | 0 | 0 | 0 |
| NEODYMIUM | | | | | | | | | | | |
| HIGH-CIS | | | | | | | | | | | |
| DIENE ™ | | | | | | | | | | | |
| 140ND (phr) | | | | | | | | | | | |
| LCB-CPR | 0 | 0 | 0 | 0 | 0 | 30 | 40 | 50 | 60 | 70 | 80 |
| (phr) | | | | | | | | | | | |
| N234 carbon | 80 | 80 | 80 | 80 | 80 | 80 | 80 | 80 | 80 | 80 | 80 |
| black (phr) | | | | | | | | | | | |
| ZEOSIL ™ | 0 | 0 | 0 | 0 | 0 | 0 | 0 | 0 | 0 | 0 | 0 |
| 1165MP silica | | | | | | | | | | | |
| (phr) | | | | | | | | | | | |
| Silane X 50-S ® | 0 | 0 | 0 | 0 | 0 | 0 | 0 | 0 | 0 | 0 | 0 |
| (phr) | | | | | | | | | | | |
| SUNDEX ® | 32.5 | 32.5 | 32.5 | 32.5 | 32.5 | 32.5 | 32.5 | 32.5 | 32.5 | 32.5 | 32.5 |
| 8125 (oil) (phr) | | | | | | | | | | | |
| Stearic acid | 1 | 1 | 1 | 1 | 1 | 1 | 1 | 1 | 1 | 1 | 1 |
| (phr) | | | | | | | | | | | |
| NOCHEK ® | 1.5 | 1.5 | 1.5 | 1.5 | 1.5 | 1.5 | 1.5 | 1.5 | 1.5 | 1.5 | 1.5 |
| 4756A (phr) | | | | | | | | | | | |
| SANTOFLEX ® | 2 | 2 | 2 | 2 | 2 | 2 | 2 | 2 | 2 | 2 | 2 |
| 6PPD (phr) | | | | | | | | | | | |
| KADOX ® 911 | 2.5 | 2.5 | 2.5 | 2.5 | 2.5 | 2.5 | 2.5 | 2.5 | 2.5 | 2.5 | 2.5 |
| (phr) | | | | | | | | | | | |

Final Batch

| | | | | | | | | | | | |
|---|---|---|---|---|---|---|---|---|---|---|---|
| DPG (phr) | 0.0 | 0.0 | 0.0 | 0.0 | 0.0 | 0.0 | 0.0 | 0.0 | 0.0 | 0.0 | 0.0 |
| CBS (phr) | 1.35 | 1.35 | 1.35 | 1.35 | 1.35 | 1.35 | 1.35 | 1.35 | 1.35 | 1.35 | 1.35 |
| Sulfur (phr) | 1.35 | 1.35 | 1.35 | 1.35 | 1.35 | 1.35 | 1.35 | 1.35 | 1.35 | 1.35 | 1.35 |
| Total (phr) | 222.2 | 222.2 | 222.2 | 222.2 | 222.2 | 222.2 | 222.2 | 222.2 | 222.2 | 222.2 | 222.2 |

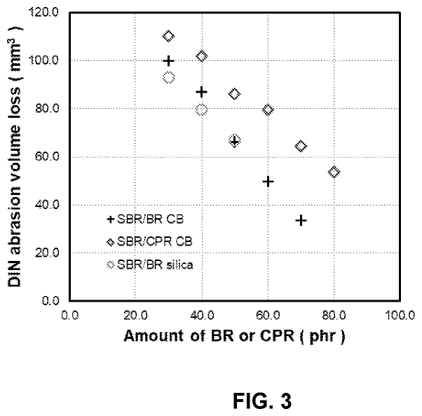

Samples 1-5 (comparative examples) were made of a blend of SBR and cis-BR with a blend ratio of from 70/30 to 30/70. Samples 6 and 11 (comparative examples) were made of a blend of SBR and LCB-CPR with a blend ratio at 70/30 and 20/80, respectively. Samples 7-10 (inventive examples) were made of a blend of SBR and LCB-CPR with a blend ratio of from 60/40 to 30/70. Cure characteristics of the samples, as well as their corresponding viscoelastic predictors for cured samples are summarized in Table 2. The LCB-CPR demonstrated strong affinity to the reinforcing filler carbon black. The immiscible blend of 30 phr to 60 phr of SBR and 40 phr to 70 phr of LCB-CPR (Samples 7-10) provided improved balanced properties of the rubber compounds, with better wet skid resistance (tan δ at −8° C., strain at 0.20%), better wear loss resistance (tan δ at 60° C., strain at 2.0%), and superior tire handling (G′ at at 60° C., strain at 2.0%), when compared to Samples 1-6 and 11. For example, the wear loss value of Sample 8 (50 phr of SBR and 50 phr of LCB-CPR) was lower than that of Sample 1 (70 phr of SBR and 30 phr of cis-BR). When compared to Sample 6 (70 phr of SBR and 30 phr of LCB-CPR), the wear loss values of Sample 7 (60 phr of SBR and 40 phr of LCB-CPR) and Sample 8 (50 phr of SBR and 50 phr of LCB-CPR) seemed comparable. However, values of the wear loss should be combined with the abrasive resistance of the rubber compound in order to evaluate the deterioration/resistance to scratching abrasion under specific conditions. Thus, when the wear loss value of the samples were combined with the data obtained from the DIN Abrasion testing (see Table 3 and FIG. 3), the DIN volume loss (mm³) of Sample 6 was higher than that of Samples 7-8, which indicated a belier resistance to abrasion of the immiscible blend of 30 phr to 60 phr of SBR and 40 phr to 70 phr of LCB-CPR. Moreover, the Samples 7-10 showed belier wear loss and abrasion resistance when compared to Samples 1-6 and 11.

TABLE 2

| Samples | | | | | | | | | | |
|---|---|---|---|---|---|---|---|---|---|---|
| 1 | 2 | 3 | 4 | 5 | 6 | 7 | 8 | 9 | 10 | 11 |

Master Batch

| | | | | | | | | | | | |
|---|---|---|---|---|---|---|---|---|---|---|---|
| SBR NIPOL ® | 70 | 60 | 50 | 40 | 30 | 70 | 60 | 50 | 40 | 30 | 20 |
| NS116R (phr) | | | | | | | | | | | |
| Cis-BR | 30 | 40 | 50 | 60 | 70 | 0 | 0 | 0 | 0 | 0 | 0 |
| NEODYMIUM | | | | | | | | | | | |
| HIGH-CIS | | | | | | | | | | | |
| DIENE ™ | | | | | | | | | | | |
| 140ND (phr) | | | | | | | | | | | |
| LCB-CPR | 0 | 0 | 0 | 0 | 0 | 30 | 40 | 50 | 60 | 70 | 80 |
| (phr) | | | | | | | | | | | |
| N234 carbon | 80 | 80 | 80 | 80 | 80 | 80 | 80 | 80 | 80 | 80 | 80 |
| black (phr) | | | | | | | | | | | |
| ZEOSIL ™ | 0 | 0 | 0 | 0 | 0 | 0 | 0 | 0 | 0 | 0 | 0 |
| 1165MP silica | | | | | | | | | | | |
| (phr) | | | | | | | | | | | |
| Silane X 50- | 0 | 0 | 0 | 0 | 0 | 0 | 0 | 0 | 0 | 0 | 0 |
| S ® (phr) | | | | | | | | | | | |

Cure Testing at 160° C., 0.5° for 45 minutes

| | | | | | | | | | | | |
|---|---|---|---|---|---|---|---|---|---|---|---|
| ML (dN · m) | 2.72 | 2.74 | 2.89 | 2.91 | 3.03 | 2.94 | 3.30 | 3.31 | 3.23 | 3.60 | 3.85 |
| MH (dN · m) | 14.56 | 14.85 | 15.03 | 15.18 | 15.48 | 16.09 | 16.47 | 17.29 | 17.85 | 18.99 | 20.08 |
| MH − ML | 11.84 | 12.11 | 12.15 | 12.27 | 12.44 | 13.15 | 13.17 | 13.97 | 14.61 | 15.40 | 16.23 |
| (dN · m) | | | | | | | | | | | |
| tc₉₀ (minute) | 9.53 | 9.14 | 9.2 | 8.53 | 8.54 | 11.27 | 9.8 | 9.2 | 8.3 | 8.22 | 8.15 |

ARES temperature ramp at 10 Hz, 2° C./min, strain at 0.20% for T < 0 ° C. and 2.0% at T ≥ 0° C.

| | | | | | | | | | | | |
|---|---|---|---|---|---|---|---|---|---|---|---|
| tan δ at −8° C., | 0.207 | 0.166 | 0.148 | 0.135 | 0.129 | 0.426 | 0.356 | 0.314 | 0.268 | 0.229 | 0.200 |
| strain at 0.20% | | | | | | | | | | | |
| tan δ at 60° C., | 0.303 | 0.282 | 0.292 | 0.289 | 0.262 | 0.295 | 0.299 | 0.281 | 0.273 | 0.266 | 0.254 |
| strain at 2.0% | | | | | | | | | | | |
| G′ at 60° C., | 5.89 | 6.37 | 6.56 | 6.91 | 6.08 | 6.53 | 7.07 | 7.43 | 7.37 | 7.61 | 7.99 |
| strain at 2.0% | | | | | | | | | | | |
| (MPa) | | | | | | | | | | | |

Table 3 and FIG. 3 illustrate the rotary drum DIN Abrasion testing as measured according to ASTM D5963 test method (3 specimens tested per sample). As the volume loss decreases, the abrasion resistance increases. Samples 7-10 demonstrated a good abrasion resistance when compared to the samples that did not contain 40 phr to 70 phr of LCB-CPR and weren't filled with carbon black.

TABLE 3

| | Amount of | | | DIN volume | |
|---|---|---|---|---|---|
| | cis-BR or | Polymer | | loss mm³ | Standard |
| Samples | CPR (phr) | Blends | Filler* | (average) | Deviation |
| 1 | 30 | SBR/cis-BR | CB | 100.0 | 4.0 |
| 2 | 40 | SBR/cis-BR | CB | 87.0 | 3.0 |
| 3 | 50 | SBR/cis-BR | CB | 66.3 | 1.5 |
| 4 | 60 | SBR/cis-BR | CB | 49.7 | 2.9 |
| 5 | 70 | SBR/cis-BR | CB | 33.7 | 2.1 |
| 6 | 30 | SBR/LCB- | CB | 110.3 | 5.5 |
| | | CPR | | | |
| 7 | 40 | SBR/LCB- | CB | 102.0 | 3.6 |
| | | CPR | | | |
| 8 | 50 | SBR/LCB- | CB | 86.3 | 5.0 |
| | | CPR | | | |
| 9 | 60 | SBR/LCB- | CB | 79.7 | 4.6 |
| | | CPR | | | |
| 10 | 70 | SBR/LCB- | CB | 64.7 | 0.6 |
| | | CPR | | | |
| 11 | 80 | SBR/LCB- | CB | 53.7 | 0.6 |
| | | CPR | | | |
| 12 | 30 | SBR/cis-BR | silica | 93.0 | 2.6 |
| 13 | 40 | SBR/cis-BR | silica | 79.7 | 0.6 |
| 14 | 50 | SBR/cis-BR | silica | 67.0 | 2.0 |

*CB is N234 carbon black; silica is ZEOSIL ™ 1165MP silica

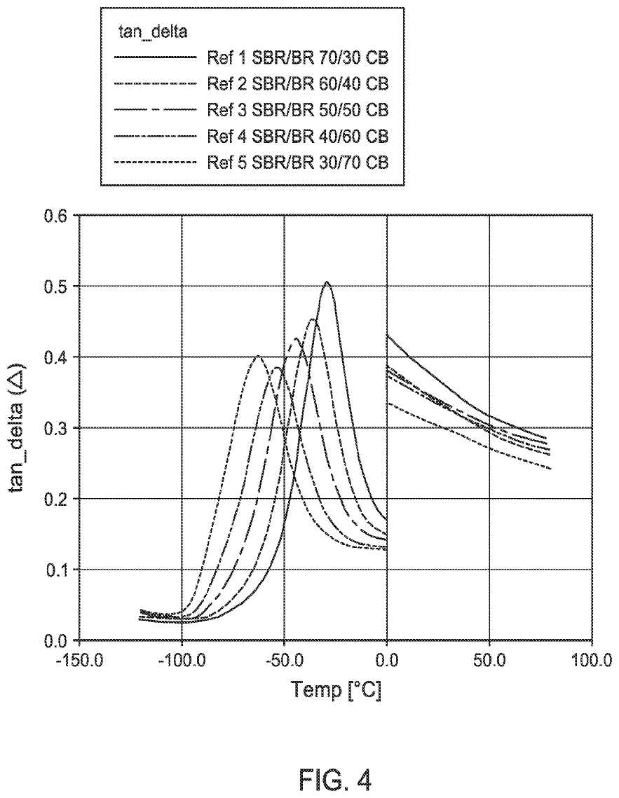

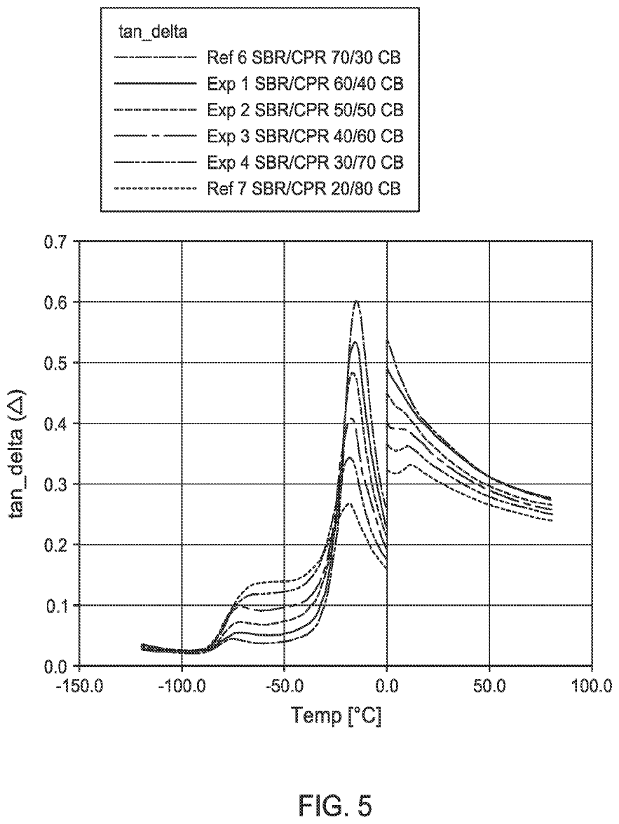

FIGS. 2 and 3 illustrate the dynamic temperature ramp testing of Samples 1-5 (FIG. 4) and Samples 6-11 (FIG. 5), which depict the variation of tan δ as function of the temperature (° C.). One peak in tan δ appeared for all the samples made of a blend of SBR and cis-BR (i.e., Samples 1-5), indicating a miscible blend of SBR and cis-BR. Two peaks in tan δ appeared for all the samples made of a blend of SBR and LCB-CPR (Samples 6, 11, and 7-10), indicating an immiscible blend of SBR and LCB-CPR with a trans content of 85%. For each samples, when the amount of SBR increased, the wet traction was improved. However, when the amount of SBR increased, the peaks for all samples shifted to higher temperature area, indicating that as tan δ increased, the rolling (resistance) loss also increased (i.e., poor rolling loss). On the other hand, when the amount of LCB-CPR increased, the rolling loss at 50° C.-60° C. decreased (better rolling loss). Furthermore, the dynamic temperature ramp testing (FIGS. 2 and 3) has shown that, for example, increasing the tan δ at 0° C. measure of the tread rubber compound correlated to improved wet traction. Conversely, lowering tan δ at 60° C. correlated to improved rolling resistance. Generally, conventional tread rubber compounds that optimize tan δ at one temperature negatively impact tan δ at the other temperature, and therefore one component of tread performance is traded for another. Inventive samples 7-10 exhibited both improved rolling resistance and improved wet traction.

### Silica-Filled Model Passenger Tire Tread Compounds (Tables 4-5, FIGS. 4-5).

Samples 12-14 (comparative examples) were made of a blend of SBR and cis-BR with a blend ratio of from 70/30 to 50/50. Sample 15 (inventive examples) was made of a blend of SBR and LCB-CPR with a blend ratio of 60/40.

TABLE 4

Samples

| | | | |
|---|---|---|---|
| 12 | 13 | 14 | 15 |

Master Batch

| | | | | |
|---|---|---|---|---|
| SBR NIPOL ® | 70 | 60 | 50 | 60 |
| NS116R (phr) | | | | |
| Cis-BR | 30 | 40 | 50 | 0 |
| NEODYMIUM | | | | |
| HIGH-CIS DIENE ™ | | | | |
| 140ND (phr) | | | | |
| LCB-CPR (phr) | 0 | 0 | 0 | 40 |
| N234 carbon | 0 | 0 | 0 | 0 |
| black (phr) | | | | |
| ZEOSIL ™ | 80 | 80 | 80 | 80 |
| 1165MP silica (phr) | | | | |
| Silane X 50-S ® | 12.8 | 12.8 | 12.8 | 12.8 |
| (phr) | | | | |
| SUNDEX ® 8125 | 32.5 | 32.5 | 32.5 | 32.5 |
| (oil) (phr) | | | | |
| Stearic acid (phr) | 1 | 1 | 1 | 1 |
| NOCHEK ® | 1.5 | 1.5 | 1.5 | 1.5 |
| 4756A (phr) | | | | |
| SANTOFLEX ® | 2 | 2 | 2 | 2 |
| 6PPD (phr) | | | | |
| KADOX ® 911 (phr) | 2.5 | 2.5 | 2.5 | 2.5 |

Final Batch

| | | | | |
|---|---|---|---|---|
| DPG (phr) | 2.0 | 2.0 | 2.0 | 2.0 |
| CBS (phr) | 1.7 | 1.7 | 1.7 | 1.7 |
| Sulfur (phr) | 1.4 | 1.4 | 1.4 | 1.4 |
| Total (phr) | 237.4 | 237.4 | 237.4 | 237.4 |

The cure characteristics of the samples, as well as the viscoelastic predictors for the cured samples are summarized in Table 5. When compared to the samples having a blend of SBR and cis-BR (Samples 12-14), Sample 15 (60 phr of SBR and 40 phr of LCB-CPR) exhibited a better wet skid resistance (tan δ at −8° C., strain at 0.2000, higher than that of Samples 12-14), better wear loss (tan δ at 60° C., strain at 2.0%, lower than that of Samples 12-14), and similar tire handling G′ at 60° C.

TABLE 5

| | Samples | | | |
|---|---|---|---|---|
| | 12 | 13 | 14 | 15 |
| SBR NIPOL ® | 70 | 60 | 50 | 60 |
| NS116R (phr) | | | | |
| Cis-BR | 30 | 40 | 50 | 0 |
| NEODYMIUM | | | | |
| HIGH-CIS DIENE ™ | | | | |
| 140ND (phr) | | | | |
| LCB-CPR (phr) | 0 | 0 | 0 | 40 |
| N234 carbon | 0 | 0 | 0 | 0 |
| black (phr) | | | | |
| ZEOSIL ™ | 80 | 80 | 80 | 80 |
| 1165MP silica | | | | |
| (phr) | | | | |
| Silane X 50-S ® | 12.8 | 12.8 | 12.8 | 12.8 |
| (phr) | | | | |

Cure Testing at 160° C., 0.5° for 45 minutes

| | | | | |
|---|---|---|---|---|
| ML (dN · m) | 2.12 | 2.28 | 2.72 | 2.63 |
| MH (dN · m) | 20.51 | 20.57 | 21.48 | 22.21 |
| MH − ML (dN · m) | 18.39 | 18.29 | 18.76 | 19.58 |
| tc₉₀(minute) | 18.13 | 12.94 | 12.74 | 21.28 |

ARES temperature ramp at 10 Hz, 2° C./min, strain at
0.20% for T < 0° C. and 2.0% at T ≥ 0° C.

| | | | | |
|---|---|---|---|---|
| tan δ at −8° C., | 0.255 | 0.210 | 0.176 | 0.427 |
| strain at 0.20% | | | | |
| tan δ at 60° C., | 0.211 | 0.212 | 0.208 | 0.193 |
| strain at 2.0% | | | | |
| G′ at 60° C., | 6.97 | 6.78 | 7.33 | 6.96 |
| strain at 2.0% (MPa) | | | | |

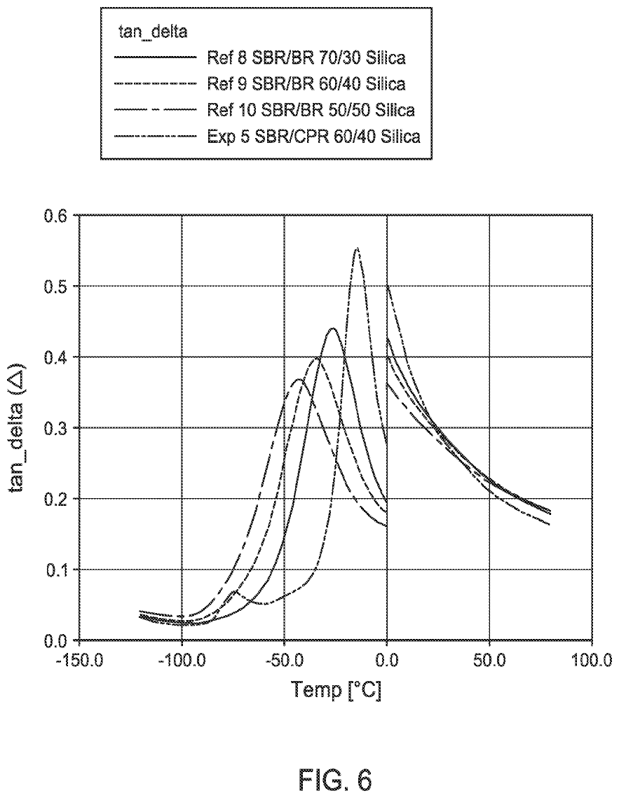

FIG. 6 illustrates the dynamic temperature ramp testing of Samples 12-15, which depict the variation of tan δ as function of the temperature (° C.). One peak in tan δ appeared for all the samples made of a blend of SBR and cis-BR (i.e., Samples 12-14), indicating a miscible blend of SBR and cis-BR. Two peaks in tan δ appeared for the sample made of a blend of SBR and LCB-CPR (Sample 15), indicating an immiscible blend of SBR and LCB-CPR with a trans content of 85%. For each samples, when the amount of SBR increased, the wet traction was improved. However, when the amount of SBR increased, the peaks for all samples shifted to higher temperature area, indicating that as tan δ increased, the rolling (resistance) loss also increased (i.e., poor rolling loss). On the other hand, when the amount of LCB-CPR increased, the rolling loss at 50° C.-60° C. decreased (better rolling loss). Furthermore, the dynamic temperature ramp testing (FIG. 6) has shown that, for example, increasing the tan δ at 0° C. measure of the tread rubber compound correlated to improved wet traction. Conversely, lowering tan δ at 60° C. correlated to improved rolling resistance. Generally, conventional tread rubber compounds that optimize tan δ at one temperature negatively impact tan δ at the other temperature, and therefore one component of tread performance is traded for another. Inventive sample 15 exhibited both improved rolling resistance and improved wet traction.

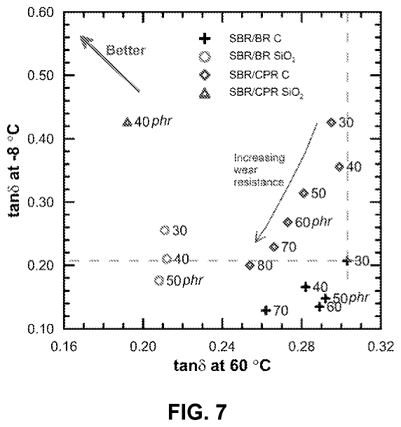

FIG. 7 is a plot depicting the comparison between the wet traction predictor (i.e., tan δ at −8° C.) and the rolling loss predictor (i.e., tan δ at 60° C.) of the samples made from the blend SBR/cis-BR filled with carbon black (Samples 1-5), the samples made from the blend SBR/LCB-CPR filled with carbon black (Samples 6-11), the samples made from the blend SBR/cis-BR filled with silica (Samples 12-14), the sample made from the blend SBR/LCB-CPR filled with silica (Sample 15). The data points were distributed in four areas on the map according to the four different types of blends described above. In terms of rolling loss predictor (i.e., tan δ at 60° C.), a gap between carbon black-filled samples and silica-filled samples was observed. Within the carbon black-filled samples made of a blend of SBR and LCB-CPR, an overall trend was clear that as the amount of LCB-CPR increased, the rolling loss predictor decreased, while the wear resistance increased. Compared to Sample 1, a carbon black-filled sample made of a blend of SBR and LCB-CPR with the amount of LCB-CPR in the range of from about 40 phr to about 70 phr can result in balanced improvement of critical tire performance characteristics and break the well-known tire performance compromise. The same principle consideration is also expected to hold for compounds reinforced mainly with silica or a mixture of silica and carbon black. As a result, the enhanced affinity to the reinforcing fillers, specifically carbon black, when using LCB-CPR with cis-to-trans ratio of 20:80 to 10:90, provided the desired improved passenger car tires properties. Also, the use of resin for further tuning of the rubber compounds viscoelasticity and material strength improvement have been observed.

Thus, in comparison to a control tread compound made of SBR and BR with the amount of BR≤35 phr, an experimental tread compound can be made of a blend of SBR and LCB-CPR with the amount of LCB-CPR in the range of about 40 phr to about 70 phr. The immiscible SBR component with relatively high Tg can provide the viscoelastic damping for enhancement of wet skid resistance. In the blend, with increasing amounts of LCB-CPR having low Tg, tire rolling loss can keep reducing while tire wear resistance can be expected to keep increasing. On the other hand, in the blend, when the amount of LCB-CPR having low Tg is higher than 70 phr, the wet skid resistance of the rubber compound can be worse than that for the control tread compound made of SBR and BR with the amount of BR≤35 phr. Hence the importance of finding an optimal range of LCB-CPR in the blend for balanced improvement of tire performance characteristics.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” “having,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A rubber compound for passenger tires comprising:
40 to 70 parts by weight per hundred parts by weight rubber (phr) of a long chain branched cyclopentene ring-opening rubber (LCB-CPR) having a glass transition temperature (Tg) of −120° C. to −80° C., a g′ᵥᵢₛ of 0.50 to 0.91, and a ratio of cis to trans of 40:60 to 5:95,
30 phr to 60 phr of a styrene-butadiene rubber (SBR), wherein the SBR has a glass transition temperature (Tg) of −60° C. to −5° C.,
50 phr to 110 phr of a reinforcing filler, and
20 phr to 50 phr of a process oil.

2. The rubber compound of claim 1, wherein the LCB-CPR has a weight average molecular weight (Mw) of 1 kDa to 1,000 kDa.

3. The rubber compound of claim 1, wherein the LCB-CPR has a melting temperature of 10° C. to 20° C.

4. The rubber compound of claim 1, wherein the long chain branched cyclopentene ring-opening rubber (CPR) has an Mw divided by Mn of 1 to 10.

5. The rubber compound of claim 1, wherein the SBR has a Mooney viscosity (ML(1+4) at 100° C.) of 40 MU to 50 MU.

6. The rubber compound of claim 1, wherein the reinforcing filler comprises carbon black, silica, or a mixture thereof.

7. The rubber compound of claim 1, wherein the rubber compound has a cross-linking density (MH-ML) after curing at 160° C., 0.5° for 45 minutes of 10 dN.M to 25 dN.M.

8. The rubber compound of claim 1, wherein the rubber compound has a wet skid resistance (tan δ at −8° C., strain at 0.20%) of 0.1 to 0.7.

9. The rubber compound of claim 1, wherein the rubber compound has a wear loss (tan δ at 60° C., strain at 2.0%) of 0.1 to 0.45.

10. The rubber compound of claim 1, wherein the rubber compound has a tire handling (G′ at 60° C., strain at 2.0%) of 4 MPa to 10 MPa.

11. The rubber compound of claim 1, wherein the rubber compound has a DIN abrasion volume loss of 40 mm³ to 130 mm³.

12. The rubber compound of claim 1 further comprising:
0.1 phr to 15 phr of a vulcanizing agent and/or a crosslinking agent, wherein optionally the rubber compound is at least partially crosslinked.

13. A method comprising:
compounding: 40 to 70 parts by weight per hundred parts by weight rubber (phr) of a long chain branched cyclopentene ring-opening rubber (LCB-CPR) having a glass transition temperature (Tg) of −120° C. to −80° C., a g′ᵥᵢₛ of 0.50 to 0.91, and a ratio of cis-to-trans of 40:60 to 5:95; 30 phr to 60 phr of a styrene-butadiene rubber (SBR), wherein the SBR has a glass transition temperature (Tg) of −60° C. to −5° C.; 50 phr to 110 phr of a reinforcing filler; and 20 phr to 50 phr of a process oil to form a rubber compound.

14. The method of claim 13, wherein the rubber compound further comprises 0.1 phr to 15 phr of a vulcanizing agent and/or a crosslinking agent, and wherein the method further comprises:
at least partially crosslinking the rubber compound.

15. The method of claim 13 further comprising:
molding the rubber compound into a passenger tire tread, wherein the tire tread has a depth of 15/32 of an inch or less.

16. A passenger tire tread comprising: a rubber compound that comprises:
40 to 70 parts by weight per hundred parts by weight rubber (phr) of a cyclopentene ring-opening rubber (CPR) having a glass transition temperature (Tg) of −120° C. to −80° C., and a ratio of cis to trans of 40:60 to 5:95,
30 phr to 60 phr of a styrene-butadiene rubber (SBR), wherein the SBR has a glass transition temperature (Tg) of −60° C. to −5° C.,
50 phr to 110 phr of a reinforcing filler, and
20 phr to 50 phr of a process oil.

17. The passenger tire tread of claim 16, wherein the rubber compound is at least partially crosslinked.

18. The passenger tire tread of claim 16, wherein the tire tread has a depth of 15/32 of an inch or less.

19. The passenger tire tread of claim 16, wherein the rubber compound is at least partially crosslinked and has a depth of 15/32 of an inch or less.
